(19) United States
(12) Patent Application Publication
(10) Pub. No.: US 2013/0167628 A1
(43) Pub. Date: Jul. 4, 2013

(54) METHOD AND APPARATUS FOR DETECTING AN ACOUSTIC EVENT ALONG A CHANNEL

(71) Applicant: HiFi Engineering Inc., Calgary (CA)

(72) Inventors: John Hull, Calgary (CA); Seyed Ehsan Jalilian, Calgary (CA)

(73) Assignee: HiFi Engineering Inc., Calgary (CA)

(21) Appl. No.: 13/682,502

(22) Filed: Nov. 20, 2012

Related U.S. Application Data
(63) Continuation-in-part of application No. 12/438,479, filed on Jun. 23, 2009, now Pat. No. 8,326,540.
(60) Provisional application No. 60/901,299, filed on Feb. 15, 2007.

(51) Int. Cl. G01V 1/00; G06F 17/00; G01V 8/10

(52) U.S. Cl. CPC G01V 1/001; G01V 8/10; G06F 17/00
USPC 73/152.58

(57) ABSTRACT

The present disclosure is directed at methods, apparatuses, and techniques for detecting an acoustic event along a channel. Different wavelengths of an optical signal are multiplexed along a fiber optic strand extending along the channel. The strand has groups of transducers located along its length, and all of the transducers in any one of the groups reflect a tuned wavelength when not under strain. The wavelength that the transducers reflect changes in response to strain. Optical signal processing equipment receives reflected optical signals from the groups of transducers, and determines, for each of the groups of transducers, differences between wavelengths of the optical signals reflected by the transducers of that group and the tuned wavelength for that group. The differences correspond to the loudness of the event measured by that group of transducers, which can then be graphically represented to a person for analysis.

### CROSS REFERENCE TO RELATED APPLICATIONS

This application is a Continuation-in-Part of U.S. application Ser. No. 12/438,479, filed on Jun. 23, 2009, which is a U.S. National Stage of PCT/CA2008/000314, filed Feb. 12, 2008, which claims the benefit of U.S. Provisional Application Ser. No. 60/901,299, filed Feb. 15, 2007, all of which prior applications are incorporated by reference herein.

### TECHNICAL FIELD

The present disclosure is directed at methods, apparatuses, and techniques for detecting an acoustic event along a channel.

### BACKGROUND

Production and transportation of oil and gas generally involves transporting the oil and gas along various types of channels. For example, during conventional oil and gas production, oil and gas are pumped out of a formation via production tubing that has been laid along a wellbore; in this example, the production tubing is the channel. Similarly, when fracking is used to produce oil and gas, the well in which the fracking is performed is the channel. As another example, oil and gas, whether refined or not, can be transported along a pipeline; in this example, the pipeline is the channel. In each of these examples, acoustic events may occur along the channel that are relevant to oil and gas production or transportation. For example, the pipeline or the production tubing may be leaking, and during fracking new fractures may be formed and existing fractures may expand. Each such event is an acoustic event as it makes a noise while it is occurring. It can accordingly be beneficial to detect the presence of these types of acoustic events.

### SUMMARY

According to a first aspect, there is provided a method for detecting an acoustic event along a channel. The method comprises multiplexing different wavelengths of an optical signal along a fiber optic strand extending along the channel that has groups of transducers located along its length, wherein all of the transducers in any one of the groups reflect a tuned wavelength when not under strain and wherein the wavelength reflected by any one of the transducers changes in response to strain experienced by that transducer; receiving reflected optical signals from the groups of transducers; determining, for each of the groups of transducers, differences between wavelengths of the optical signals reflected by the transducers of that group and the tuned wavelength for that group, wherein the differences correspond to the loudness of the event measured by that group of transducers; and graphically representing the loudness of the event measured by each of the groups of transducers.

In one exemplary aspect, none of the tuned wavelengths of any of the groups of transducers is identical.

The transducers comprise fiber Bragg gratings.

The tuned wavelengths of each of the transducers of any one of the groups may be identical.

All of the transducers in any one of the groups may be located consecutively along the fiber strand.

The method may further comprise monitoring the signal being returned by any one of the groups of transducers; comparing the magnitude of the signal being monitored to an event threshold; and when the magnitude of the signal satisfies the event threshold, determining that the group of transducers returning the signal being monitored has detected the event.

Signals being returned by at least two of the groups of transducers may be simultaneously monitored and compared to the event threshold.

The method may further comprise estimating location of the acoustic event over a period of time by performing a method comprising determining magnitudes of the signals returned by the groups of transducers during the period of time; and determining the location of the acoustic event as being nearest to the group of transducers having the highest magnitude during the period of time.

The channel may comprise production tubing extending within production casing.

The event may comprise one or both of oil and gas passing through the production casing.

The event may be selected from the group consisting of: sanding, water flow, and steam injection.

The channel may comprise a pipeline.

The acoustic event may comprise a leak in the pipeline.

The channel may comprise a fracking observation well.

The acoustic event may comprise creation or expansion of a fracture from a fracking well.

According to another aspect, there is provided an apparatus for detecting an acoustic event along a channel. The apparatus comprises a fiber optic sensor assembly comprising groups of transducers spaced from each other along a fiber optic strand, wherein each of the groups of transducers is configured to measure the event and output a signal; and optical signal processing equipment configured to digitize the signals and to perform any of the foregoing methods.

According to another aspect, there is provided a non-transitory computer readable medium having statements and instructions encoded thereon to cause a processor to perform any of the foregoing methods.

According to another aspect, there is provided a method for detecting an acoustic event along a channel. The method comprises biasing groups of piezoelectric transducers located along an electrical cable extending along the channel, wherein all of the transducers in any one of the groups is biased using a carrier signal oscillating at a carrier frequency specific to that group and wherein the transducers of different groups are biased using carrier signals of different frequencies; receiving frequency multiplexed electrical signals from the groups of transducers; determining, for each of the groups of transducers, the loudness of the acoustic event as measured by that group of transducers; and graphically representing the loudness of the event measured by each of the groups of transducers.

The electrical signals may be amplitude or frequency modulated in proportion to the loudness of the acoustic event.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more exemplary embodiments:

FIG. 1 is a schematic side elevation view of a gas migration detection and analysis apparatus in accordance with an embodiment;

FIG. 2 is a schematic view of a fiber optic cable assembly of the gas migration detection and analysis apparatus of FIG. 1.

FIG. 3 is a schematic view of an acoustic transducer array of the fiber optic cable assembly of FIG. 2.

FIG. 4 is a functional block diagram of certain components of the cable assembly of FIG. 2 and the transducer array of FIG. 3.

FIG. 5 is a functional block diagram of components of an optical signal processing assembly of the gas migration detection and analysis apparatus of FIG. 1.

FIG. 6 is a functional block diagram of certain components of an external modulator assembly that forms part of the optical signal processing assembly of FIG. 5.

FIG. 7 is a flowchart illustrating a method for determining the static profile of a wellbore using the apparatus of FIG. 1, according to another embodiment.

FIG. 8 is a flowchart illustrating a method for determining the dynamic profile of a wellbore using the apparatus of FIG. 1, according to another embodiment.

FIG. 9 is a flowchart illustrating a method for determining the fluid migration profile of a wellbore, according to another embodiment.

FIG. 10 shows an example of an acoustic well-logging trace (right panel) with the noise peaks aligned with wellbore aberrations that result in an aberrant noise profile as gas bubbles migrate upwards.

FIG. 11A shows a 300 Hz input sine wave and FIG. 11B shows a Fast Fourier Transform of an acoustic signal obtained using a packaged transducer comprising an 80 A durometer rubber core and a 10 meter intervening length between fiber Bragg gratings.

FIG. 12A shows a 300 Hz input sine wave and FIG. 12B shows a Fast Fourier Transform of an acoustic signal obtained using a straight two transducer array having a 10 meter intervening length between fiber Bragg gratings.

FIGS. 13A and 14A each shows an input acoustic signal (top graph), and FIGS. 13B and 14B each shows a Fast Fourier Transform of the input acoustic signal of FIGS. 13A and 14A, respectively, obtained using a packaged transducer comprising an 80 A durometer rubber core and a 10 meter intervening length between fiber Bragg gratings (bottom graph).

FIG. 15 shows a schematic of a system for detecting an acoustic event along a channel according to another embodiment in which the channel is production tubing within a wellbore.

FIG. 16 shows a schematic of a system for detecting an acoustic event along a channel according to another embodiment in which the channel is a production well used for fracking.

FIG. 17 shows a schematic of a system for detecting an acoustic event along a channel according to another embodiment in which the channel is a pipeline.

FIG. 18 shows a method for detecting an acoustic event along a channel, according to another embodiment.

FIG. 19 shows a method for performing a temporal analysis on a first signal, which can comprise part of the method of FIG. 18, according to another embodiment.

FIG. 20 shows first through third signals, which respectively represent first through third zones in a pipeline, and the cumulative flow contribution of any leaks in the pipeline present in these zones.

FIG. 21 shows a method for detecting an acoustic event along a channel, according to another embodiment.

FIG. 22 shows a 3D graph of acoustic activity vs. depth and time, according to another embodiment.

### DETAILED DESCRIPTION

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment.

Apparatus

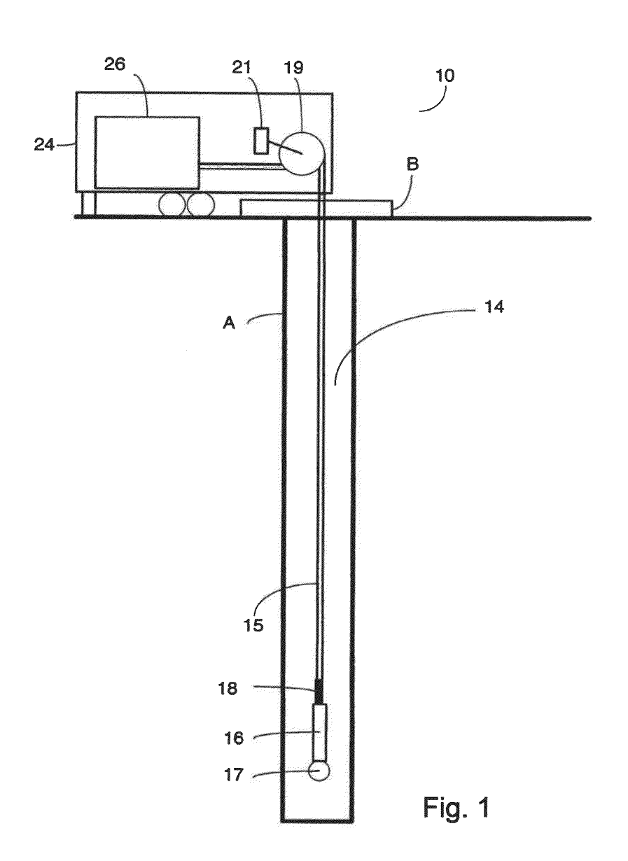

Referring to FIG. 1 and according to one embodiment, there is provided an apparatus 10 for detecting and analyzing fluid migration in an oil or gas well. Fluid migration in oil or gas wells is generally referred to as “casing vent flow” (CVF) or “gas migration” (GM) and an refer to any one or more of the following phenomena:
fluid flowing from the formation into an outermost annular portion of the wellbore behind an outermost casing string in the wellbore;
fluid flowing from the outermost annular portion of the wellbore into the formation; and
fluid flowing across any of the casing or tubing strings in the wellbore.

The fluid includes gas or liquid hydrocarbons, including oil, as well as water, steam, or a combination thereof. A variety of compounds may be found in a leaking well, including methane, pentanes, hexanes, octanes, ethane, sulphides, sulphur dioxide, sulphur, petroleum hydrocarbons (six to thirty-four carbons or greater), oils or greases, as well as other odour-causing compounds. Some compounds may be soluble in water, to varying degrees, and represent potential contaminants in ground or surface water. Any sort of aberrant or undesired fluid migration is considered a leak and the apparatus 10 is used to detect and analyze such leaks in order to facilitate repair of the leaks. Such leaks can occur in producing wells or in abandoned wells, or wells where production has been suspended.

The acoustic signals (as well as changes in temperature) resulting from migration of fluid may be used as an identifier, or ‘diagnostic’, of a leaking well. As an example, the gas may migrate as a bubble from the source up towards the surface, frequently taking a convoluted path that may progress into and/or out of the production casing, surrounding earth strata and cement casing of the wellbore, and may exit into the atmosphere through a vent in the well, or through the ground. As the bubble migrates, pressure may change and the bubble may expand or contract, and/or increase or decrease its rate of migration. Bubble movement may produce an acoustic signal of varying frequency and amplitude, with a portion in the range of 20-20,000 Hz. This migration may also result in temperature changes (due to expansion or compression) that are detectable by various embodiments described herein.

The apparatus 10 shown in FIG. 1 includes a flexible fiber optic cable assembly 14 comprising a fiber optic cable 15 and an acoustic transducer array 16 connected to a distal end of the cable 15 by an optical connector 18, and a weight 17 coupled to the distal end of the transducer array 16. The apparatus 10 also includes a surface data acquisition unit 24 that stores and deploys the cable assembly 14 as well as receives and processes raw measurement data from the cable assembly 14. The data acquisition unit 24 includes a spool 19 for storing the cable assembly 14 in coiled form. A motor 21 is operationally coupled to the spool 19 and can be operated to deploy and retract the cable assembly 14. The data acquisition unit 24 also includes optical signal processing equipment 26 that is communicative with the cable assembly 14. The data acquisition unit 24 can be housed on a trailer or other suitable vehicle thereby making the apparatus 10 mobile. Alternatively, the data acquisition unit 24 can be configured for permanent or semi-permanent operation at a wellbore site.

The apparatus 10 shown in FIG. 1 is located with the data acquisition unit 24 at surface and above an abandoned wellbore A with the cable assembly 14 deployed into and suspended within the wellbore A. While an abandoned wellbore is shown, the apparatus 10 can also be used in producing wellbores, during times when oil or gas production is temporarily stopped or suspended. The cable assembly 14 spans a desired depth or region to be logged. In FIG. 1, the cable assembly 14 spans the entire depth of the wellbore A. The acoustic transducer array 16 is positioned at the deepest point of the region of the wellbore A to be logged. The wellbore A comprises a surface casing, and a production casing (not shown) surrounding a production tubing through which a gas or liquid hydrocarbon flows through when the wellbore is producing.

At surface, a wellhead B closes or caps the abandoned wellbore A. The wellhead B comprises one or more valves and access ports (not shown) as is known in the art. The fiber optic cable assembly 14 extends out of the wellbore 12 through a sealed access port (e.g. a “packoff”) in the wellhead B such that a fluid seal is maintained in the wellbore A.

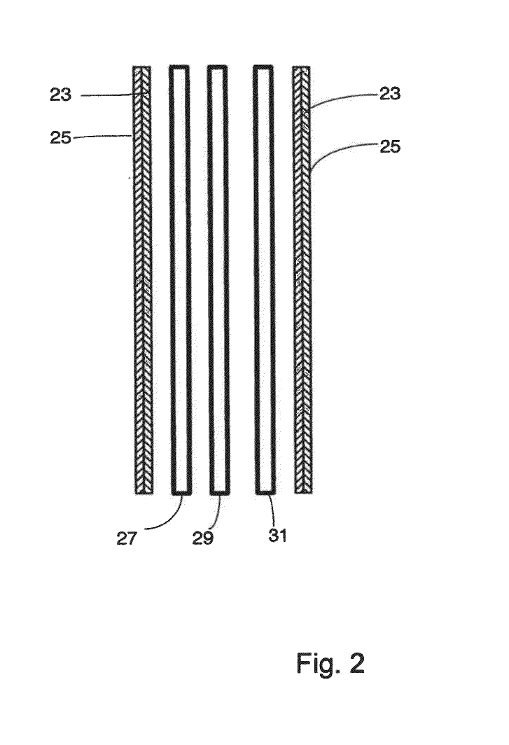

Referring now to FIG. 2, the fiber optic cable assembly 14 comprises a fiber optic cable 15, comprising a plurality of fiber optic strands. The plurality of fiber optic strands may surround a core comprising a strength member, such as a steel core. The plurality of fiber optic strands (and core, if present) are encased in a flexible protective sheath 23 surrounded by a flexible strength member and/or cladding 25. The plurality of fiber optic strands comprises at least two single mode optical fibers including a Coherent Raleigh (“CR”) transmission line 27 and a digital noise array (“DNA”) transmission line 31, and one or more multimode optical fibers extending the length of the cable 15 including a digital temperature sensing (“DTS”) transmission line 29.

One of the optical fibers 29 acts as a temperature transducer and another of the optical fibers 27 acts as an acoustic transducer. Therefore, the sheath 23 and cladding 25 material are selected to be relatively transparent to sound waves and heat, such that sound waves are transmissible through the sheath 23 and cladding 25 to the CR transmission line 27 and the DTS transmission line 29 is relatively sensitive to temperature changes outside of the cable 15. Suitable materials for the sheath include stainless steel and suitable materials for the cladding include aramid yarn and KEVLAR™. Examples of such sheaths, their composition and methods of manufacturing are described in, for example, US Publication No: 2006/0153508, or US Publication No. 2003/0202762. While the cable 15 depicted in FIG. 2 includes three different optical fibers 27,29,31, in an alternative embodiment different numbers of fibers may be used, whether they be DTS, CR, or DNA transmission lines, or another type of transmission line.

Optical fibers, such as those used in the embodiments discussed herein, are generally made from quartz glass (amorphous SiO₂). Optical fibers may be doped with rare earth compounds, such as oxides of germanium, praseodymium, erbium, or the like, to alter their refractive index, as is well known in the art. Single and multi-mode optical fibers are commercially available, for example, from Corning Optical Fibers (New York). Examples of optical fibers available from Corning include the ClearCurve™ series of fiber (bend-insensitive), SMF28 series of fiber (single mode fiber) such as SMF-28 ULL fiber or SMF-28e fiber, and the InfiniCor® series of fiber (multimode fiber)

Without wishing to be bound by theory, when light interacts with the matter in an optical fiber, Raman scattering occurs. Generally, three effects are observed: Rayleigh scattering (no energy exchange between the incident photons and the matter of the fiber occurs: the “Rayleigh band”), Stokes scattering (molecules of the optical fiber absorb energy of the incident photons, causing a shift to the red end of the spectrum: the “Stokes band”) and anti-Stokes scattering (molecules of the optical fiber lose energy to the incident photons, causing a shift to the blue end of the spectrum: the “anti-Stokes band”). The difference in energy of the Stokes and anti-Stokes bands may be determined, as is well known in the art, by subtracting the energy of the incident laser light from that of the scattered photons.

As is exploited in DTS applications, the anti-Stokes band is temperature-dependent, while the Stokes band is essentially independent of temperature. A ratio of the anti-Stokes and Stokes light intensities allows the local temperature of the optical fiber to be derived.

As is exploited in CR applications, when an acoustic event occurs downhole at any point along the optical fiber employed for CR, the strain induces a transient distortion in the optical fiber and changes the refractive index of the light in a localized manner, thus altering the pattern of backscattering observed in the absence of the event. The Rayleigh band is acoustically sensitive, and a shift in the Rayleigh band is representative of an acoustic event down hole. To identify such events, a “CR interrogator” injects a series of light pulses as a predetermined wavelength into one end of the optical fiber, and extracts backscattered light from the same end. The intensity of the returned light is measured and integrated over time. The intensity and time to detection of the backscattered light is also a function of the distance to where the point in the fiber where the index of refraction changes, thus allowing for determination of the location of the strain-inducing event.

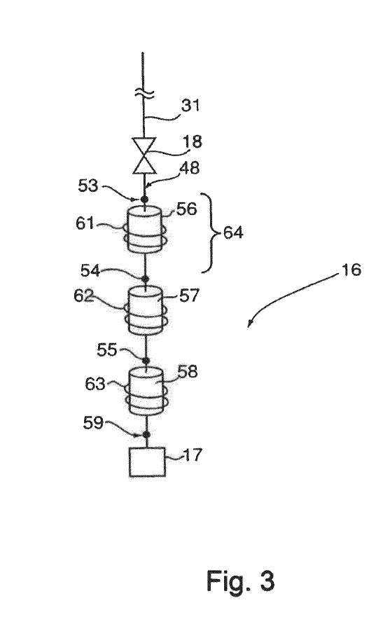

Referring to FIG. 3, the DNA transmission line 31 is optically coupled to the acoustic transducer array 16 by the optical coupling 18. The DNA transmission line 31 is also in optical communication with the optical signal processing equipment 26, as described below. The array 16 comprises a plurality of Bragg gratings 53,54,55,59 etched in a fiber optic line 48, separated by an intervening length of unetched fiber optic line 61,62,63. The intervening lengths of unetched fiber optic line 61,62,63 are individually wound about a mandrel 56,57,58. The weight 17 is attached at the distal end of the optical fiber. A transducer 64 comprises a first one of the Bragg gratings 53,54,55,59 (e.g. the uppermost Bragg grating 53 in FIG. 3), a second one of the Bragg gratings 53,54,55,59 that is adjacent to the first one of the Bragg gratings 53,54,55,59 (e.g.: the Bragg grating 54 immediately below the uppermost Bragg grating 53 in FIG. 3), and an intervening length of unetched fiber optic line 61,62,63 would about a mandrel 56,57,58 (e.g.: the unetched fiber optic line 61 between the two uppermost Bragg gratings 53,54 in FIG. 3). The end of the fiber optic line 48 is terminated with an anti-reflective means as is know in the art. Methods of making in-fiber Bragg gratings are known in the art, and are described in, for example, Hill, K. O. (1978), “Photosensitivity in optical fiber waveguides: application to reflection fiber fabrication”, Appl. Phys. Lett. 32: 647 and Meltz, G. et al. (1989), “Formation of Bragg gratings in optical fibers by a transverse holographic method”, Opt. Lett. 14:823. A publication by Erdogan (Erdogan, T. “Fiber Grating Spectra”. Journal of Lightwave Technology 15 (8): 1277-1294) describes spectral characteristics that may be achieved in fiber Bragg gratings, and provides examples of the variety of optical properties of such gratings. Generally, a small segment of the optical fiber is treated so as to reflect specific wavelengths of light, or ranges of light, and permit transmission of others and/or to act as a diffraction grating (acting as an optical filter). The small size of the etched area of a fiber Bragg grating sensor allows close spacing in an array. The fiber Bragg grating sensors may be positioned a few centimeters apart, for example about 5 to about 10 centimeters apart, giving a dense dataset for the region of the wellbore being logged. Alternatively, a plurality of different fiber Bragg grating sensors tuned for a variety of frequencies or ranges of frequencies may be clustered a few centimeters apart, and the cluster repeated a greater distance apart.

An array according to some embodiments has a plurality of transducers. For example, the array may have at least 2, at least 3, at least 4, at least 5, at least 10, at least 20, at least 30, at least 40, at least 50, at least 100, at least 200, or more transducers. For a large array having many tens or hundreds of transducers, for example an array used in a deep well (2,000 meters or more, for example), the weight of the cable and transducers may necessitate use of a core or sheath structure, or other configuration that imparts mechanical strength.

In another embodiment, the array comprises at least two transducers at each of at least two positions. For example, in an array having 20 transducers (a 20-component array), the transducers may be arranged in transducer clusters each having two sensors, and each transducer cluster being spaced 2 meters apart from an adjacent transducer cluster.

The spacing of the transducers is preferably 1.5 meters but can be anywhere in a range between 0.1 to about 10 meters. The individual Bragg gratings are considered single-point sensors. The mandrel or core around which the intervening length of optical fiber is wound is the sensing element or mechanism. It is about 10 inches long and generally cylindrical. The mandrel may be of any suitable length and diameter combination, and the diameter and/or length may be longer to accommodate a greater intervening length of fiber optic cable. The core may be comprised of any suitable material or combination of materials that cooperate to provide the desired effect. Examples include rubbers of various durometers, elastomers, silicones or other polymers, or the like. In other embodiments, the core may comprise a hollow shell filled with a fluid, an acoustic gel, or an oil, or a solid or semi-solid medium capable of transmitting or permitting passage of the relevant frequencies. The relevant frequences may be generally in the range of 20-20,000 kHz. Selection of core size, composition, arrangement of the cable on the core (i.e. number of windings, density or spacing of winding, etc) is within the ability of one skilled in the relevant art. Without wishing to be limited by theory, wrapping or winding the intervening length of fiber optic cable between a first and a second fiber Bragg grating around a core may increase the amount of fiber optic cable sensing the signal due to the increase in effective fiber cross section axially along the sensing area. The core may act as an “amplifier” of the change in pressure in response to fluid migration. Distortion of the core in response to change in pressure conveys the distortion to a greater length of the sensing fiber, thus increasing the distortion to be detected by an interferometer and allow detection of a pressure change that would not otherwise be reliably differentiated over background noise. In some embodiments, the composition and dimensions of the mandrel and degree of wrapping of optical fiber wrapped about the mandrel may allow for selective blocking or reduction of sensitivity to acoustic signals above, below, or within a particular frequency range, thus fulfilling a role as a physical bandpass filter.

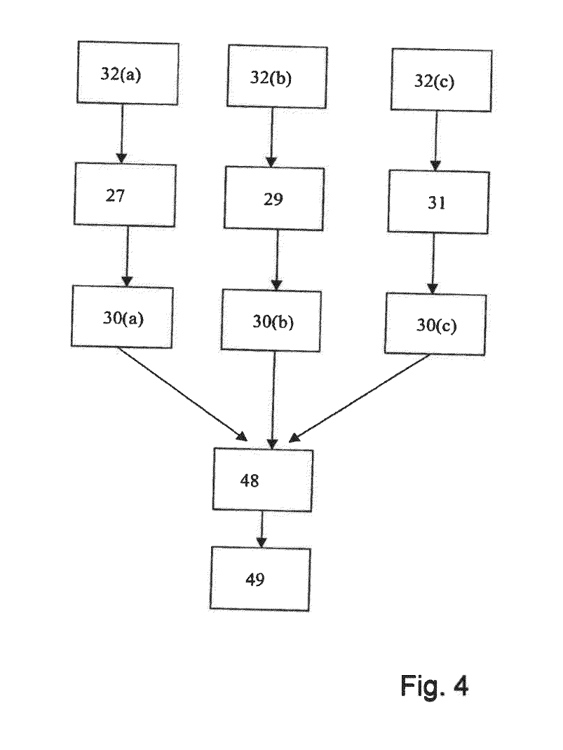

Referring now to FIG. 4, the apparatus 10 also includes optical signal processing equipment 26 which is communicatively coupled to the CR, DTS and DNA transmission lines 27,29,31. The optical signal processing equipment 26 includes three laser light assemblies 32(a),(b),(c), and three demodulating assemblies 30(a),(b),(c).

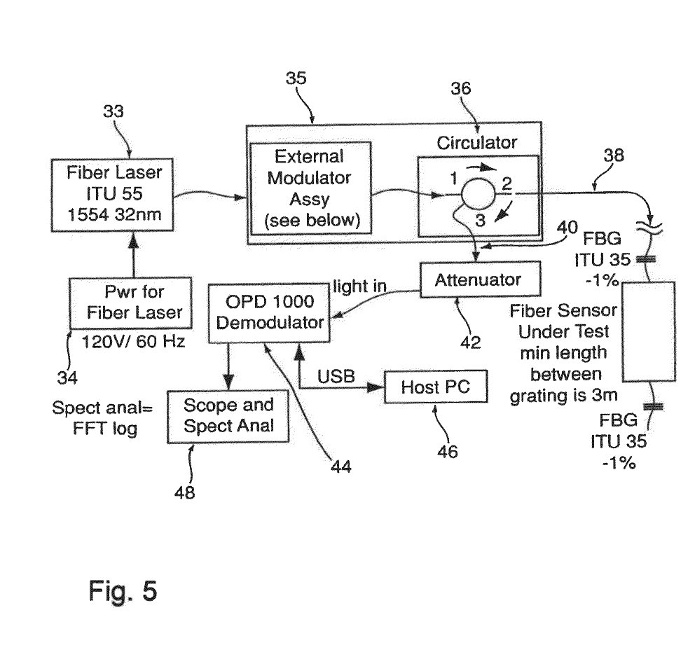

Referring now to FIG. 5, each laser light assembly 32(a),(b),(c) has a laser source 33, a power source 34 for powering the laser source 33, an external modulator 35 having an input optically coupled to the output of the laser source 33, a circulator 36 having an input optically coupled to an output of the modulator 35 and an input/output 38 optically coupled to one of the transmission lines 27,29,31. Each circulator 36 also has an output 40 optically coupled to an attenuator 42 of the demodulating assembly 30(a),(b),(c). Each demodulating assembly 30(a),(b),(c) has the attenuator 42, which in turn is optically coupled to a demodulator 44. Each demodulator 44 is electronically coupled to a digital signal processor 46 for signal processing and digital filtering and then to a host personal computer (PC) for data processing and analysis.

The laser source 33 can be a fiber laser powered by a 120V/60 Hz power source 34. A suitable laser has an output wavelength in the range from about 1300 nm to about 1600 nm, e.g. from about 1530 to about 1565 nm. Laser sources suitable for use in with the apparatus described herein may be obtained from, for example, Orbits Lightwave Inc. (Pasadena Calif.).

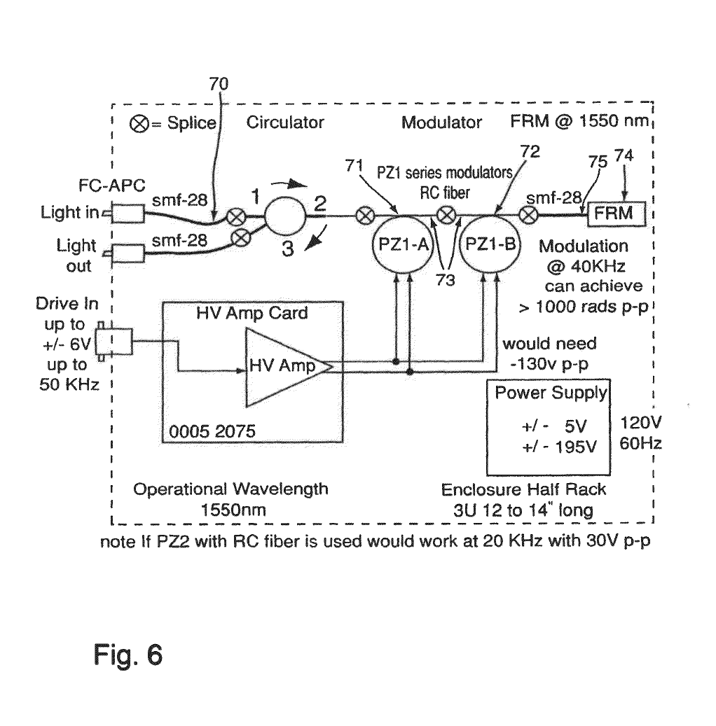

The external modulator 35 is a phase modulator for the laser source 33. Components of an external modulator 35 are illustrated in FIG. 6. Light from the laser source 33 is conveyed to a circulator 36 via optical fiber 70. The circulator 36 is in optical communication with first 71 and second 72 fiber stretchers (e.g. Optiphase PZ-1 Low-profile Fiber Stretcher) via spliced RC fiber 73. Further optically coupled to the circulator 36 and fiber stretchers 71,72 is an FRM @ 1550 nm 74 via optical fiber 75 spliced to RC fiber 73. Modulation of such a system at 40 kHz with ˜130 V peak power may be used.

The circulator 36 controls the light transmission pathway between a respective laser light assembly 32(a),(b),(c), transmission line 27,29,31, and demodulator assembly 30(a),(b),(c). When a light pulse from the laser light source is to be directed into the transmission line, the circulator 36(a),(b),(c) is selected so that a light transmission path is defined between the external modulator 34(a),(b),(c) and the transmission line 27,29,31. When reflected light in the transmission line 27,29,31 (“leak measurement data”) is to be detected, the circulator 36 is selected so that a light transmission path is defined between the transmission line 27,29,31 and the attenuator 42.

The attenuator 42 is a Mach-Zehnder interferometer, which is a device used to determine the phase shift caused by a sample which is placed in the path of one of two collimated beams (thus having plane wavefronts) from a coherent light source. Such a device is well known in the art and thus not described in detail here.

The optical phase demodulator 44 is an instrument for measuring interferometric phase of the leak measurement data from the transmission lines 27,29,31. The demodulator may be, for example, a digital signal processor-based large angle optical phase demodulator that performs demodulation of the optical signal output from the attenuator 42.

The demodulated electronic signal from the demodulator 30a, b, c is input into a first digital signal processor 48. Encoded on of the digital signal processor 48 are digital signal processing algorithms including a Fast Fourier Transform (FFT) algorithm. The processor 48 applies the FFT to the signal to pull out the frequency components from background noise of the leak measurement data.

In an alternate embodiment an Optiphase PZ2 High efficiency fiber stretcher may be used instead of the PZ1; If the PZ2 is used with the RC fiber as shown, modulation at 20 kHz with 30 V peak power may be used.

An example of a component of the data acquisition unit that may be useful in the apparatus and methods described herein is the OPD4000 phase modulator (Optiphase Inc. of Van Nuys, Calif.).

The data output from the processor 48 is then input into a second digital signal processor 49. The second processor 49 has a memory with an integrated software package encoded thereon (“software”). The software receives the raw leak measurement data from the digital signal processor 48, processes the data to obtain a gas migration profile of the wellbore A and displays the data in a user readable graphical interface. As will be discussed in detail below under “Software”, the software obtains the gas migration profile by subtracting a static profile of the wellbore A from a dynamic profile of same. Both static and dynamic profiles are measured by the apparatus 10.

The apparatus and equipment described above may be housed in the data acquisition unit 24 in a conventional manner. In some embodiments each of the apparatus for CR, DTS and DNA logging are operated independently of one another, and are provided with separate components: laser source, power supply, external modulator, demodulator, host PC, oscilloscope and first and second processors and the like. Alternately, some or all of the components for each of the CR, DTS and DNA logging may be shared; for example, there may be a single laser source with a splitter to provide the appropriate wavelength of light suited for each application. In some embodiments, it may be advantageous to process the datasets in one processor, or in a series of processors in communication with one another, to enable time-synchronous data to be more accurately obtained.

The data acquisition unit 24 may comprise hardware and software suitable for the operation of the data acquisition unit, including the steps and methods described below. Computer hardware components include a central processing unit (CPU); digital signal processing units; computer readable memory (e.g. optical disks, magnetic storage media, flash memory, flash drive, solid state hard drive, or the like); computer input devices such as a mouse or other pointing devices, keyboards, and touchscreens; and display devices such as monitors, printers or the like.

Operation

The apparatus 10 is operated to obtain static and dynamic profiles of the wellbore A using CR, DTS and DNA techniques.

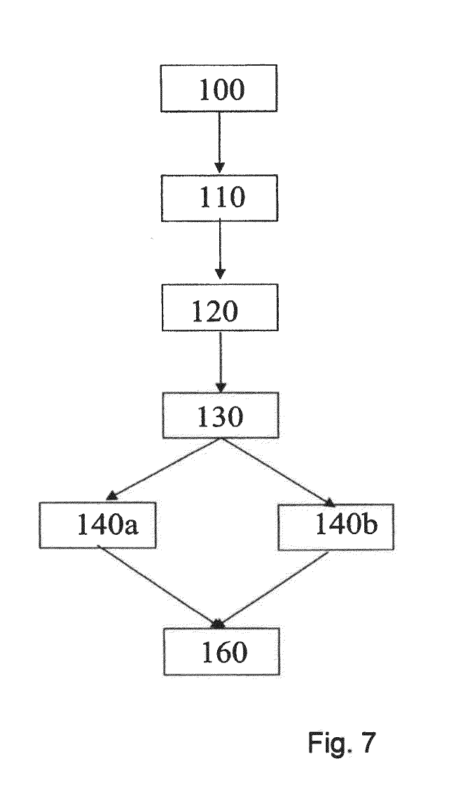

Referring to FIG. 7, the static profile of the wellbore A is obtained as follows:
Block 100: Place fiber optic cable assembly 14 (including array of fiber optic transducers 16) in the wellbore A at a first location (e.g. bottom of well, or most distal point), spanning the region to be logged (“logging region”);
Block 110: Pressurize wellbore A (close vent or apply positive atmospheric pressure, e.g. pump air down it) and allow to equilibrate (hours to days, depending on the well, nature of fluid leak, etc.). Without wishing to be bound by theory, acoustic events related to fluid migration will cease when the well is pressurized (sealed and allowed to equilibrate, or positively pressurize, or a combination of both, depending on the circumstance). Acoustic events unrelated to fluid migration (e.g. aquifer activity) will not cease when the well is sealed or pressurized, and can be identified as such in the static profile.
Block 120: Operate laser light assemblies 32(a),(b),(c) to send laser light down each of the CR, DTS and DNA transmission lines 27,29,31 and:
   (a) collect static CR data over logged region (time series);
   (b) collect static DTS data over logged region (time series);
   (c) collect static DNA data of first array span of logged region (time series), using the acoustic transducer array 16 by:
      (i) raising array by one array span, collecting static acoustic data of second/subsequent array span of logged region (time series); and
      (ii) repeating for entire length of logged region.
Block 130: Operate demodulating assemblies 30(a),(b),(c) to demodulate collected static CR/DTS/DNA signal data and measure the interferometric phase of same.
Block 140a: Apply the FFT to the demodulated CR/DNA signal data to extract the frequency components from background noise in the data.
Block 140b: Integrate DTS data series over time (small occurrences become amplified; for example, a temperature change due to a leak may not be large for any one sampling, but over time [e.g. sampling each second, or microsecond] the small changes accumulate).
Block 160: Output a “static profile” for each of CR, DTS and DNA datasets spanning logged region of the wellbore A.

Either of block 140a or 140b is included in the method, depending on the data to be processed.

In block 120, static CR data is collected by pulsing laser light of defined wavelength from the laser source down the CR transmission line 27 (an optical fiber), which is reflected back in a pattern intrinsic to the optical fiber. When an acoustic event occurs downhole at any point along the CR transmission line 27 the strain on the optical fiber induces a distortion event in the retransmitted later light and this distortion event is identifiable by the demodulator 30(a) as a variant in the pattern. The scattering of the light (Raman scattering) in response to the variants in the optical fiber 27 provides (in response to the initial single wavelength of light sent down) a set of peaks at several wavelengths, one of which is similar to the initial wavelength sent down (Rayleigh band) and is “acoustically sensitive” if interrogated in a suitable manner. This is the Coherent Raleigh wavelength.

In block 120, static DTS data is collected by pulsing laser light of a defined wavelength and frequency down the DTS transmission line 29 (an optical fiber), which is reflected back in a pattern intrinsic to the optical fiber. Temperature is measured by the transmission line 29 as a continuous profile (optical fiber 29 functions as a linear sensor). A localized temperature change in the wellbore A will be measurable as a distortion in the fiber optic in the vicinity of the temperature change. The resolution of the DTS transmission line 29 is generally high (spatially about 1 meter, with accuracy within ˜1 degree C.) and resolution of ˜0.01 degree C. In some embodiments, the temperature range being detected may be from about zero degrees to above 400 degrees Celsius or more, or from about 10 degrees Celsius to about 200 degrees Celsius, or any range therebetween; or may be a more moderate range from about 10 degrees Celsius to about 150 degrees Celsius, or any range therebetween; or from about 20 degrees Celsius to about 100 degrees Celsius; or any range therebetween. Such “distributed temperature sensing” is known in the art (see, for example, Dakin, J. P. et al., “Distributed Optical Fibre Raman Temperature Sensor using a semiconductor light source and detector”, Electronics Letters 21, (1985), pp. 569-570; WO 2005/054801 describes improved methods for DTS generally, and thus not discussed in any further detail here).

Optical time domain reflectometry (OTDR) is well known in the art for use with DTS to determine the location of temperature changes, and thus not discussed in any further detail here. See, for example, Danielson 1985 (Applied Optics 24(15):2313) for a description of OTDR specifications and performance testing

In block 120, static DNA data is collected by pulsing laser light of a defined wavelength and frequency down the DNA transmission line 31 (an optical fiber) to the acoustic transducer array 16. The array 16 comprises a plurality of Bragg gratings, each having a characteristic reflection wavelength (the frequency to which it is “tuned”) about which it serves as an optical filter. In the absence of a strain-inducing event (e.g. an acoustic event) the returned light reflection is “background” or steady state (a different wavelength for each grating). When an event occurs, strain causes distortion and the reflected light pattern varies at the gratings closest to the event (or those most affected by it, e.g. those experiencing the greatest amplitude of strain.)

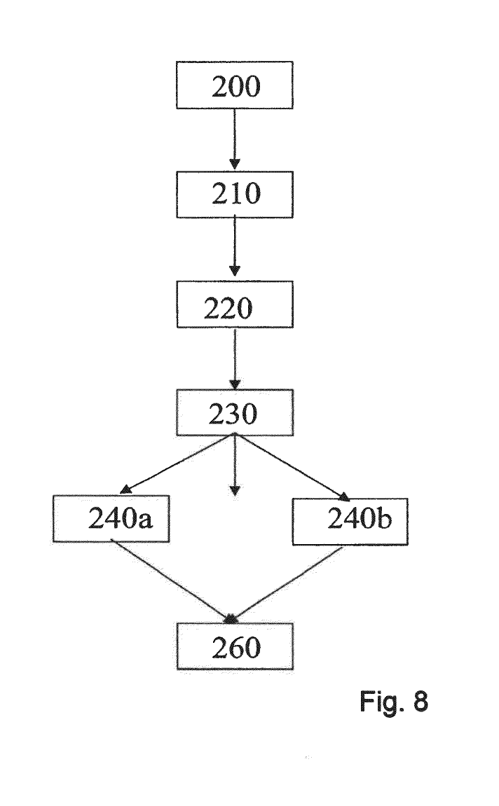

Referring to FIG. 8, the dynamic profile of the wellbore A is obtained as follows:
Block 200: Following acquisition of static CR, DTS and DNS data, reposition fiber optic cable assembly at the first location, spanning the logging region;
Block 210: Open vent of wellbore and allow fluid migration to resume; any leaking fluid will flow and the bubbles will generate noise and/or temperature anomalies e.g. cold spots due to gas expansion in an otherwise largely linear geothermal temperature gradient (increasing with depth). Alternately, a negative atmospheric pressure may be applied (a vacuum) to stimulate fluid migration. Other gas formations or aquifers may also cause temperature anomalies. A 3D geophysical map of the region (usually done as part of the exploration process when determining where to place the well and how deep) would indicate the location of known aquifers and may be used to identify temperature and/or acoustic anomalies in the CR and DTS data streams as being unrelated to a leak. Alternately, an aquifer may have a temperature and acoustic profile that differs significantly from that of a fluid migration event, and be specifically identified on the basis of a temperature/sound profile. Then:
   (a) collect dynamic CR data over logged region;
   (b) collect dynamic DTS data over logged region; and
   (c) collect DNA data of first array span of logged region, using acoustic transducer array 16 by:
      (i) raising array by one array span, collect dynamic acoustic data of second/subsequent array span of logged region; and
      (ii) repeating for entire length of logged region.
Block 230: Operate demodulating assemblies 30(a),(b),(c) to demodulate collected static CR/DTS/DNA signal data and measure the interferometric phase of same.
Block 240a: Apply the FFT to the demodulated CR/DNA signal data to pull out the frequency components from background noise in the data.
Block 240b: Integrate DTS data series over time (small occurrences become amplified; for example, a temperature change due to a leak may not be large for any one sampling, over time [e.g. sampling each second, or microsecond] the small changes accumulate)
Block 260: Output a “dynamic profile” for each of CR, DTS and DNA datasets spanning logged region of wellbore.

Either of blocks 240a or 240b is included in the method depending on the data to be processed.

For each station log (block 210 (c) (i)), acoustic samples may be collected in duplicate or triplicate (e.g., three 30-second acoustic samples for each array span). Each acoustic sample is assessed for quality and similarity to the other sample(s). If the samples demonstrate sufficient similarity, the data is considered to be “valid” and the array is raised and the acoustic sampling repeated. Similarity is assessed as described for the static profile.

For each DNA step (block 120 (c)(i) or block 210 (c)(i)), acoustic samples may be collected at least in duplicate, preferably in triplicate (e.g., three 30-second acoustic samples for each array span). Each acoustic sample may span a time interval ranging from about 1 second to about 1 hour, to about 8 hours or more if desired. Preferably, the time interval is from about 10 seconds to about 2 minutes, or from about 30 seconds to about 1 minute. In an array having a larger number of transducers, a longer array span may be sampled at each step, thus decreasing the number of steps required to cover the logged region.

Each acoustic sample is assessed for quality and similarity to the other sample(s). If the samples demonstrate sufficient similarity, the data is considered to be “valid” and the array is raised and the acoustic sampling repeated.

Similarity between samples may be judged by the operator, or may be assessed statistically. For example, samples may be considered to demonstrate sufficient similarity if the difference between them is not statistically significant. As another example, when acoustic data is sampled, the periodic nature of a bubble is identifiable when the pressure is released (e.g. as per block 210 above). A sporadic event such as the fiber optic cable or other component of the fiber optic assembly contacting or striking the side of the casing would not be expected to repeat itself periodically either in the static or dynamic profiles. The irregularity of such sporadic events, and/or the regularity of a bubble of fluid migrating allows for identification or differentiation of such events from those of the migrating fluid. In the event that a sample is considered to be not “valid”, repetition of the acoustic sampling may be prompted.

Any of several known multiplexing techniques may be used to differentiate the signal received from each individual grating in the transducer array 16. Wavelength division multiplexing (WDM) and time division multiplexing (TDM) are both useful. Time to return to the surface is how the controlling software determines where the acoustic event is occurring. For example, signals coming back from the fiber in between the shallower gratings 53,54 will be returned sooner than those coming back from the deeper gratings 55,59.

With respect to determination of physical location of the array, the length of the overall fiber optic cable assembly 14 is known, including the array of fiber optic transducers 16. For example, in a system with an overall length of 2,000 meters, one will have a signal trace that is 2,000 m long (including the cable wound on the spool). The controlling software is in communication with the data acquisition unit 24, and records the length of cable deployed; thus the depth at which the array 16 is deployed is known, as is the relative spacing between each of the Bragg gratings. The section of the temperature or acoustic profile that corresponds to the section of the fiber optic assembly remaining on the spool is subtracted from the profile when the data is processed (see “Software” section below, for further details).

Use of digital signal processing technology removes the dependence on analog filters, circuits, and amplifiers, providing an enhanced signal-to-noise ratio, which in turn may increase the accuracy of fluid migration detection. Additionally, digital signal processing enables real-time processing of the resulting data, and the reduced bandwidth requirements allow for use of multiple transducers. An array of transducers allows for enhanced accuracy in pinpointing the location of the leak, as spatial calculations may be performed, comparing amplitude variations and time lapse in the signal between the different transducers to determine the position of the leak relative to the array.

In summary, the transducer in the DNA noise array comprising the mandrel, optical fiber, and pair of Bragg gratings, or the optical fiber for CR, converts an acoustic signal into an optical signal. In DTS, the optical fiber is also the transducer and it is a temperature change that is converted into an optical signal; the optical signal is transmitted to the phase modulator which converts the optical signal into an electronic representation of the acoustic signal or temperature change. The electronic representation of the acoustic signal is subjected to an FFT while the temperature change data is integrated over time. The resulting transformed or integrated data is the static profile or dynamic profile of the wellbore for CR/DTS/DNA measurements fed to the software for processing to obtain the fluid migration profile.

During operation, signals or data may be received continuously during sampling and repositioning steps, or selectively, for example, only during monitoring steps.

Integrated Software Package

The software comprises statements and instructions for (1) obtaining a fluid migration profile of a wellbore, and (2) differentiating or identifying events in the obtained fluid migration profile. The software obtains a fluid migration profile by subtractive filtering of a static profile from each of the CR, DTS and DNA datasets of a wellbore against a dynamic profile of same. The static and dynamic profile datasets are collected by the apparatus 10 in a manner as described in detail below.

Subtractive filtering removes or cancels out elements and events common to both the static and dynamic profiles on the basis that such common elements and events represent environmental non-fluid migration elements and events. The remaining data thus represents the fluid migration profile of each of the CR, DTS and DNA datasets.

The software also differentiates or identifies events in the obtained fluid migration profile, as follows:
Block 300: S static profile for each of CR, DTS and DNA is subtracted from the dynamic profile of each of CR, DTS and DNA datasets spanning the logged region of the wellbore, to obtain the fluid migration profile of the logged region of the wellbore.
Block 310: CR fluid migration profile is compared with each of DTS fluid migration profile and DNA fluid migration profile.
Block 320a: CR, DTS and/or DNA fluid migration profiles compared with other well logging profiles, 3D geophysical map data, cement bond condition or the like.

The subtraction of the CR, DTS and DNA static profiles from the CR, DTS and DNA dynamic profile is a digital filtering step, and removes frequency elements form the dynamic profile that are also represented in the static profile, and thus may be considered to be “background” noise (noise refers to background signals generally, including temperature elements, not only acoustic events). For a feature in a fluid migration profile to be considered representative of a leak, the feature ideally is present only in the dynamic profile. For example, an acoustic event detected at a depth common to both static and dynamic profiles would be filtered out in block 300. As another example, an acoustic event at a particular depth in the well (as determined by the DNA fluid migration profile) should coincide with a temperature aberration at a similar depth in the DTS fluid migration profile.

The resulting fluid migration profile may be stored on a computer-readable memory for later access or manipulation.

Therefore, some embodiments provide for a method for obtaining a fluid migration profile for a wellbore, comprising a) obtaining a static profile for the logged region of the wellbore; b) obtaining a dynamic profile for the logged region of the wellbore; and c) digitally filtering said dynamic profile to remove frequency elements represented in said static profile, to provide a fluid migration profile.

Some embodiments further provide for a computer readable memory or medium having encoded thereon methods and steps for obtaining a fluid migration profile for a wellbore, comprising a) obtaining a static profile for the logged region of the wellbore; b) obtaining a dynamic profile for the logged region of the wellbore; and c) digitally filtering the dynamic profile to remove frequency elements represented in the static profile, to provide a fluid migration profile.

Some embodiments further provide for an apparatus for obtaining a fluid migration profile for a wellbore, comprising: a) a fiber optic cable assembly and data acquisition unit for obtaining a transformed static profile and a transformed dynamic profile for a logged region of the wellbore; b) a filter for digitally filtering said transformed dynamic profile to remove frequency elements represented in said static profile; and c) a computer-readable memory for storing said fluid migration profile. Some embodiments further provide a computer program product, comprising: a memory having computer readable code embodied therein, for execution by a CPU, for receiving demodulated optical data obtained from a static profile and a dynamic profile of a wellbore, said code comprising: a) a transformation protocol for transforming demodulated data; b) an integration protocol for integrating demodulated data over time; and c) a digital filtering protocol for digitally filtering the dynamic profile to remove frequency elements represented in the static profile, to provide a fluid migration profile.

The co-occurrence (spatially and/or temporally) of patterns of temperature changes and acoustic events in a wellbore provides for fluid ingress or egress rates, locations and in some embodiments differentiation between types of fluids (gas or liquid hydrocarbon, gas or liquid water, or combinations thereof).

Other well logging profiles for the wellbore being logged may also be compared with the CR, DTS or DNA fluid migration profiles. Examples of such well logging profiles include cement bond logging (CBL), Quad Neutron Density logging (QND), or the like.

Quad Neutron Density (QND) logging allows evaluation of the casing formation through casing (e.g. equipment is deployed within the wellbore and provides information about the surrounding geological strata) and may be useful for assessing localized changes in the strata (density of the strata, etc) that may be correlated with geophysical maps and chemical sampling to identify strata types that have a higher incidence of leaks (e.g. less stable, loose sand vs. solid rock, etc.).

When the fluid migration profiles, 3D geophysical map information, cement condition profiling (CBL) and the like are aligned by depth in the wellbore, various fluid migration profile features may be correlated with known geophysical elements, other non-leak associated events or features, leaks, and in some situations, the nature of the leaking fluid. For example:
identification of an aquifer at the same depth position as a drop in temperature and/or an acoustic event in the DNA may be identified as not being associated with a leak;
a temperature change/drop (DTS) in the absence of an aquifer or acoustic events (DNA) at a similar depth may be indicative of a gaseous fluid leak;
an acoustic event in the absence of a temperature change or aquifer at a similar depth may be indicative of a liquid fluid leak, or another seismic event;
such seismic events could be correlated with natural seismic activity in the area, or artificial seismic activity associated with exploration in the area (e.g. background noise or vehicle traffic);
the regularity of the acoustic event (periodicity) is also an indicator of a gaseous fluid leak (e.g. bubbles moving regularly);
the periodicity of a leak may be differentiated from other periodic acoustic events by applying a partial vacuum to the wellbore; the periodicity and/or amplitude of the acoustic event could be expected to increase for a periodic event associated with a leak. Frequency analysis may be useful to differentiate a bubble-related event from other non-fluid migration events;
in some conditions, water, gas, steam or liquid hydrocarbons may emit different acoustic frequencies as they migrate through or around restrictions in the casing, wellbore or surrounding strata; and
software may be used to perform any one or more of the above and also to provide visual output (e.g.: aligned graphs, sliding window to view regions of the depth profile of the various datasets simultaneously, numerical output of identified events, etc.).

The software also includes statements and instructions for correlating the identification of a temperature or acoustic event with a depth in the wellbore. For CR determination of the point at which the index of refraction changes, which is the furthermost point of the optical fiber if it is undisturbed, or if it is under strain at the point of an event that induces strain in the fiber. When an acoustic event occurs downhole at any point along the CR optical fiber (e.g. above the array segment) the strain on the optical fiber induces a distortion event in the retransmitted laser light and this distortion event is identifiable by the demodulator as a variant in the pattern compared to the static profile.

In the event that the fiber optic cable does not deploy “straight down” the wellbore (e.g. there are kinks or curls in the cable), correlating the features of the static, dynamic and/or fluid migration profiles of the wellbore with known geophysical data may be useful in applying a correction factor to more accurately localize features specific to the fluid migration profile. For example, if a geophysical map indicates an aquifer at 220 meters, and the system indicates it is at 250 meters of deployed cable, a correction factor of 30 meters may be applied to the static, dynamic and/or fluid migration profiles to allow for more accurate localization of the fluid migration profile feature.

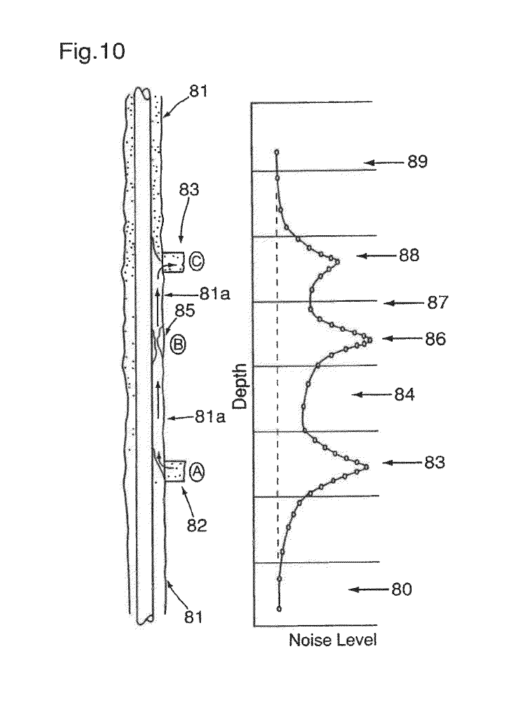

An example of processed and transformed data is shown in FIG. 10. In this example, acoustic data has been monitored and recorded over the entire depth of the wellbore. Acoustic signal level (noise) is plotted with respect to depth. A baseline level of acoustic activity (80) is initially determined. A first acoustic event peak (83) is detected at the depth at which a first fluid migration event occurs. The gas bubbles enter a cement casing (81) from the geological matrix (82) at (A), and rise up through pores or gaps (81a) in the cement casing (81). With little to no obstruction, noise is reduced (84), but the noise level does not return to background levels. A second acoustic event (86), having a different profile, is detected at (B), where there is a partial obstruction (85) of the fluid migration in the cement casing (81). This is recorded as another peak (86) on the acoustic profile. The bubbling continues traveling upwards through gaps or pores (81a) in the cement casing (81) and again noise is reduced (87) but does not reach background levels. The bubbles are diverted back into the geological matrix (82) at (C) by an obstruction in the cement casing. This obstruction and diversion results in a third acoustic event (88) (peak) on the acoustic profile. Above this depth, the cement casing (81) is intact, and no fluid migration events are detected, and the noise level returns to background.

Such fluid migration events may also occur in the casing of an oil or gas well, surrounding the production tubing, or in the area between the casing and production tubing.

### Alternative Embodiments

In some alternative embodiments, the cable having the array of transducers may be installed in the wellbore transiently. For example, an operating well with a suspected leak may be suspended and capped with cement, and the array of transducers lowered into the suspended well through an access port in the cement cap. The data is collected and analyzed, and the array then removed.

In another embodiment, the array of transducers is installed in the wellbore permanently. The wellbore may then be capped and abandoned following the usual procedures, and a data transmission apparatus installed to collect the data. Alternatively, the apparatus may be modified to convey the well logging data to a remote site by satellite or cellular phone. Examples of such a data transmission apparatus are known in the art; an example of one is a Surface Readout Unit including a satellite antenna, solar array and power cable by Sabeus, Inc.

In another embodiment, a downhole array of transducers may be used in a production survey of a well. A well may have multiple zones, each producing gas or oil at differing rates and/or with differing properties (temperature, pressure, composition and the like). Current methods of investigating zone production may involve use of a “spinner tool”, which is a mechanical, turbine-like device with fan blades that rotate according to flow rate. Such devices are prone to clogging, and may have fluctuating accuracy due to frictional interactions of the components. Use of an array of transducers spanning at least one production zone may obviate such mechanical devices by enabling passive acquisition of one or more downhole property profiles of the production zone. For example a noise, pressure, and/or temperature profile of a selected production zone may be correlated with gas or oil flow in the production tubing and/or casing from that zone.

In some other embodiments, a piezoelectric transducer may be used in conjunction with or instead of the acoustic transducer array 16. Selection of a transducer for use in an array may involve consideration of particular features related to robustness, flexibility of application, specificity of detection parameters, safety or environmental suitability, or the like. Additionally, transducers for detecting pressure, seismic vibration or temperature may be substituted for, or used in combination with at least one acoustic transducer.

As an example, in an environment in which flammable or explosive gases or fluids may be present (such as a gas or oil well), a system employing fiber Bragg gratings may provide a safety advantage over a system using electrical or electronic signal detection and/or transmission, in that the risk of sparking in an optical system is significantly reduced or may even be eliminated, thus reducing risk of explosion.

An array of transducers 16 may, once manufactured, be of a fixed resolution, where by “resolution” it is meant the distance between transducers. In order to log a region of a well with a resolution less than that of the array 16, the array may be repositioned in a staggered manner. For example, in an array having 10 transducers, each spaced 2 meters apart, the array has a 2 meter resolution, and is about 20 meters overall in length.

If a 1 meter resolution is desired, the same array may be employed. The first sampling period is performed as described above, and the array raised 1 meter for the second sampling period. For the third sampling period, the array is raised 20 meters (one array span) and the sampling is again performed. For the fourth monitoring period, the array is again raised 1 meter and the sampling performed again. This cycle of staggered raising and sampling is repeated until the desired region has been logged.

Use of a staggered raising and sampling cycle allows for a single array design to provide multiple monitoring resolutions.

### Examples

The performance of an array of two fiber Bragg grating transducers (straight array) was compared with that of a transducer having a polyurethane core or mandrel of 60 A or 80 A durometer using a test well configured to simulate gas leaks at varying depths and flow rates. For both sensors, 10 m of fiber optic cable separated the gratings. The test well comprised an outer casing extending from above ground level to below ground level, with a sealed end below ground. An inner casing in parallel and centered with the outer casing extended from the below ground end of the outer casing to above ground level. The above ground end of the inner casing was threaded to enable attachment of a union or valve, as desired. Two line pipes were used as a flow line, and for filling and/or accessing an annulus formed between the inner and outer casings. A series of six steel tubes, extending to three depths of the well annulus were arranged to place one for each depth at each of two proximities (near and far) to the inner casing. The annulus was filled with packed sand to a level below the lower end of the mid-length steel tubes. The array or packed transducer to be tested was lowered into the inner casing, and air was injected into the steel tubes to produce a fixed bubble rate. Acoustic signals were recorded in the absence of gas injection to obtain a baseline, a positive control input sine wave of 300 Hz and bubble rates ranging from 5 to 800 bubbles per minute.

The fiber optic cable comprising two fiber Bragg gratings as a straight array or in combination with a mandrel as described above was configured for testing purposes. When illuminated by an input pulse of light, a fiber Bragg grating reflects a narrow band of light at particular wavelength to which it is tuned. A length of fiber optic cable between a first and a second fiber Bragg grating responds to strain induced by an acoustic event such as an input sine wave, bubbles, background noise, or the like, by a change in the separation distance between the gratings, which in turn induces a change in the wavelength of light being reflected and scattered. A Mach-Zehnder interferometer, in communication with the surface recording, processing and monitoring equipment (host computer, 2-channel oscilloscope and power source) was used to determine the phase shift of the optical signal. The phase shift is subsequently demodulated by a Fast Fourier Transform to identify the various frequency components from the background noise. Further details of the components and steps of the overall test configuration are as described above for the digital noise array as shown in FIG. 5; an illustration of an external modulator assembly is shown in FIG. 6.

All data was taken with the sensors in the well. The interrogation approach involves a CS laser (Orbits Lightwave, Pasadena Calif.) into an external fiber stretcher (for modulation at 37 kHz), and in communication with an interferometer (sensor) having a nominal 20 meter fiber path mismatch. The refracted light was received by the demodulator (OPD4000) to measure optical phase variation.

OPD4000 Conditions:

A) Demodulation card OPD-440P (with PDR receiver) (Optiphase, Inc.)
B) Demodulation rate: 37 kHz
C) Data record was 65536 points in length (1.7 seconds in duration)
D) Data was DC coupled

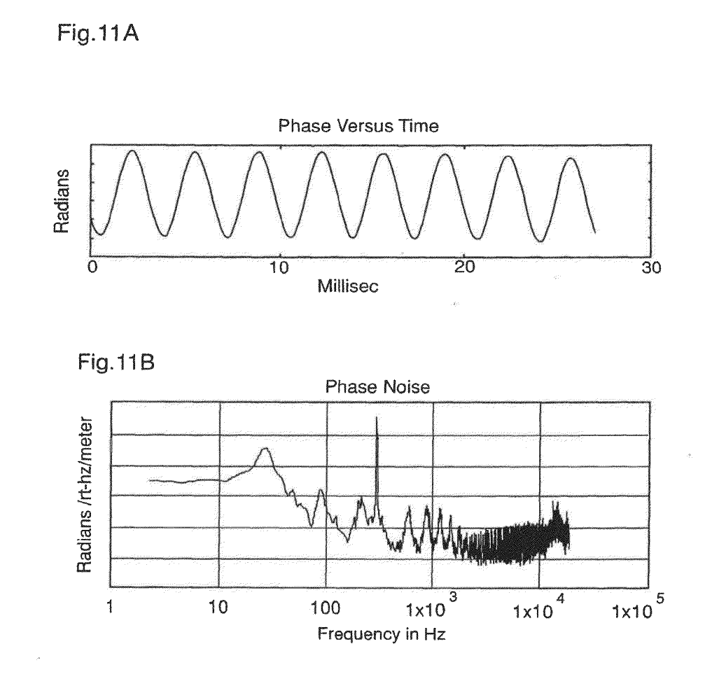

The data was processed and plotted; a time domain plot is illustrated for the first 30 msec (actual scale shown in FIGS. 11-14). A FFT of four consecutive 16384 point sets was obtained, then averaged. The FFT is normalized to 1 Hz noise bandwidth and to a 1 m fiber path mismatch.

For all sensors, Bragg gratings were made at ITU35 standard (1549.32 nm) nominally with 1% reflection (Uniform type grating) (LxSix Photonics, St-Laurent, Quebec). The high durometer sensor (Optiphase) comprised 10 meters (grating separation 10 m) of single mode fiber (with 900 um acrylate) wound on polyurethane mandrel of high durometer (80 A). The medium durometer sensor (Optiphase) comprised 10 meters (grating separation 10 m) of single mode fiber (with 900 um acrylate) wound on polyurethane mandrel of high durometer (60 A). Both mandrels were 12 inches in length, 1.5 inches in diameter.

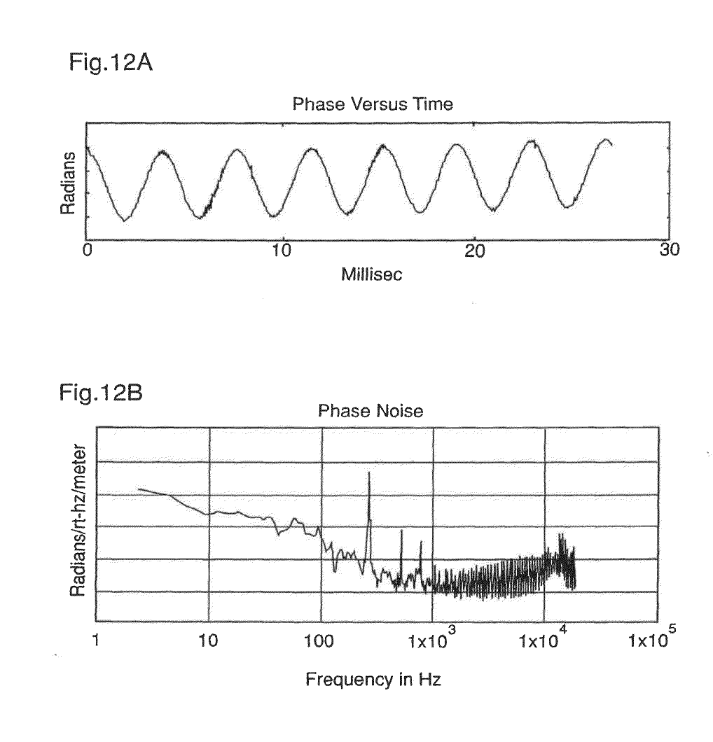

A 300 Hz sine wave input for the straight array (FIG. 12) and the 80 A durometer core transducer (FIG. 11) gave an identifiable signal. A single signal peak was identifiable in both.

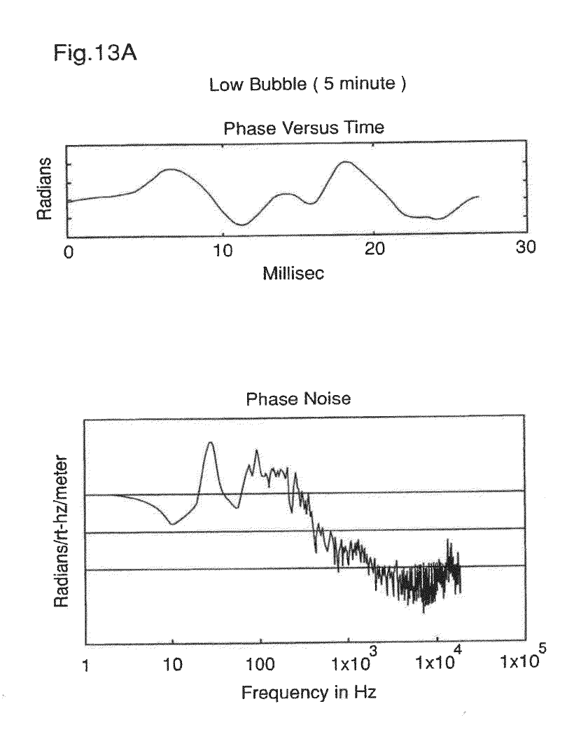

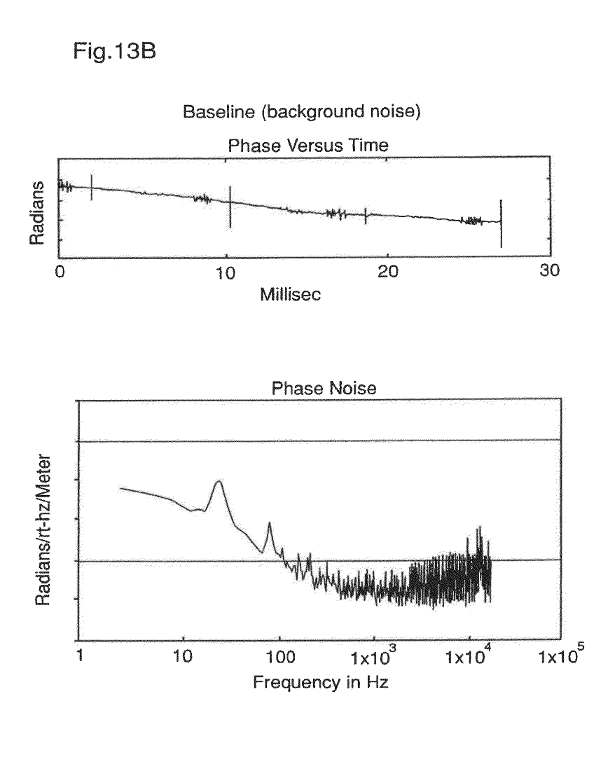

FIG. 13 shows the results of a test using a transducer having an 80 A durometer core to detect acoustic signals in the annulus of the test well at a low bubble rate (5 bubbles per minute (FIG. 13A) and at baseline (FIG. 13B).

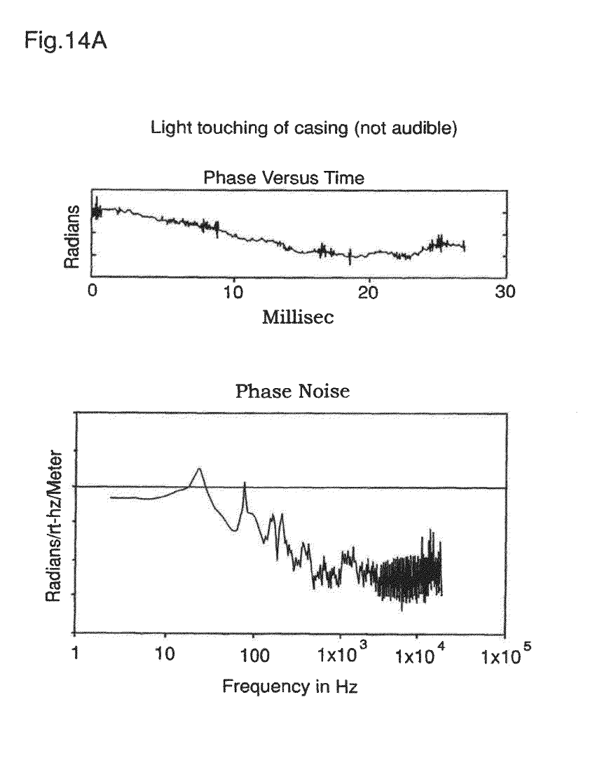

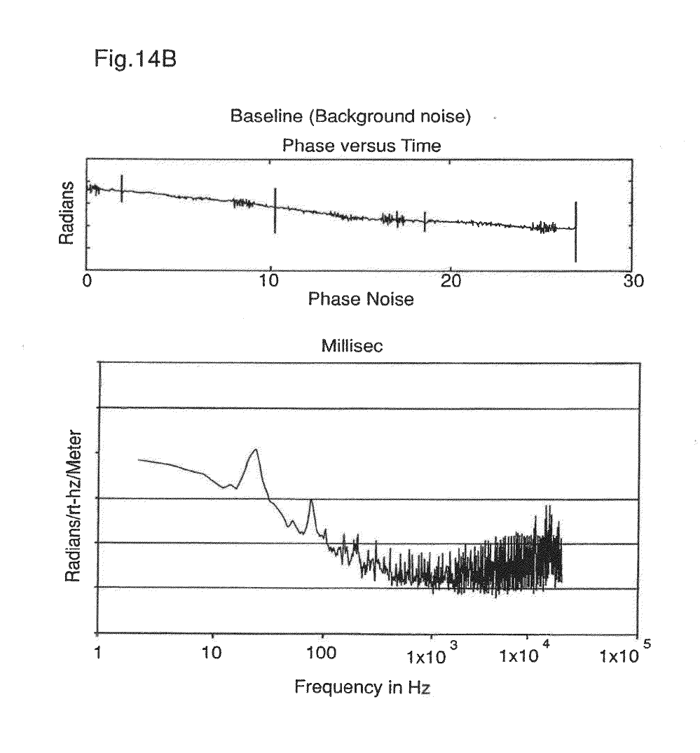

FIG. 14 shows the results of a test using a packaged transducer having an 80 A durometer core to detect acoustic signals in the annulus of the test well at baseline (FIG. 14B), and when the casing is lightly rubbed by hand (FIG. 14A). Acoustic signals generated by manual rubbing produced a profile similar in overall amplitude but with lower frequency signals and a different peak distribution relative to background, and also differing from that produced by gas bubbles in the annulus. A loss of linearity compared to the baseline is also observed.

These data demonstrate that acoustic signals produced by migrating gas bubbles are detectable and differentiable over acoustic signals produced by contact events (friction) at the ground level and over the ambient baseline noise.

Grouped Sensors Embodiment

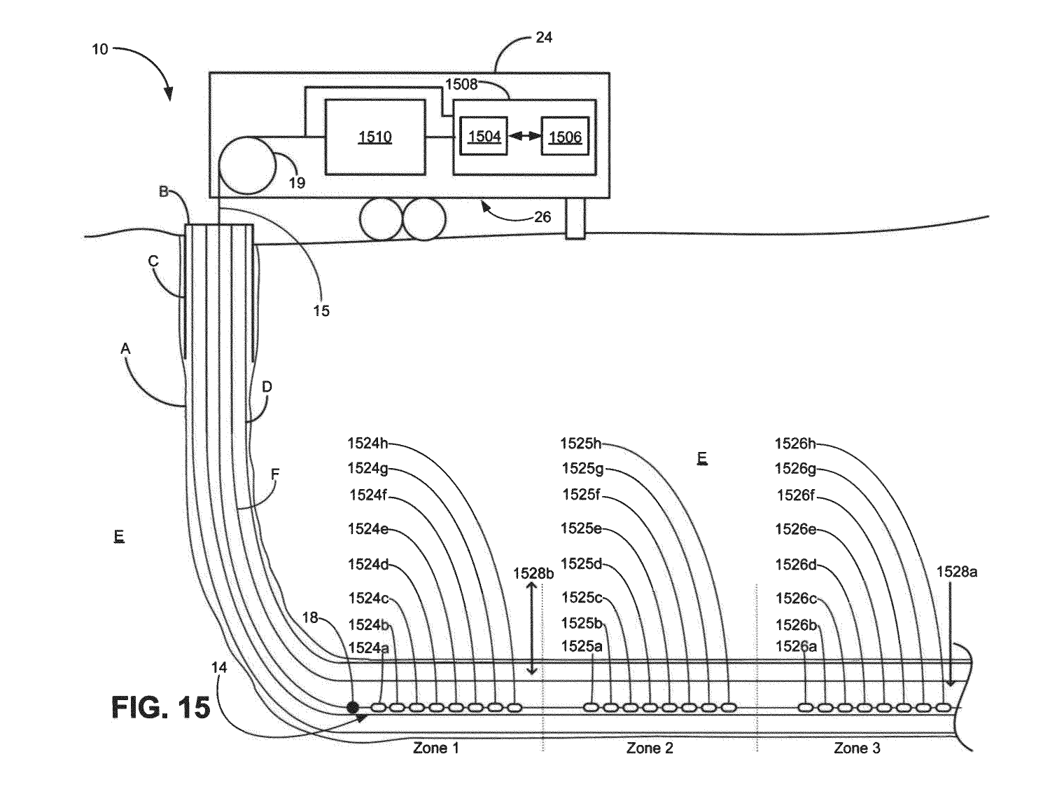

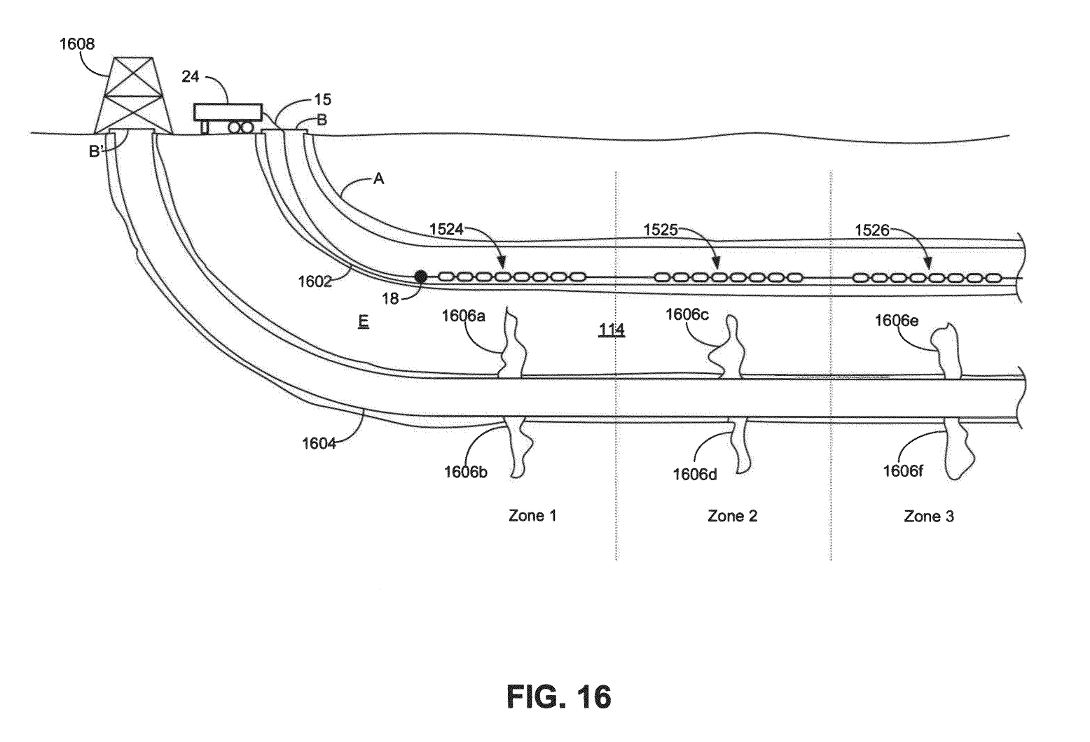

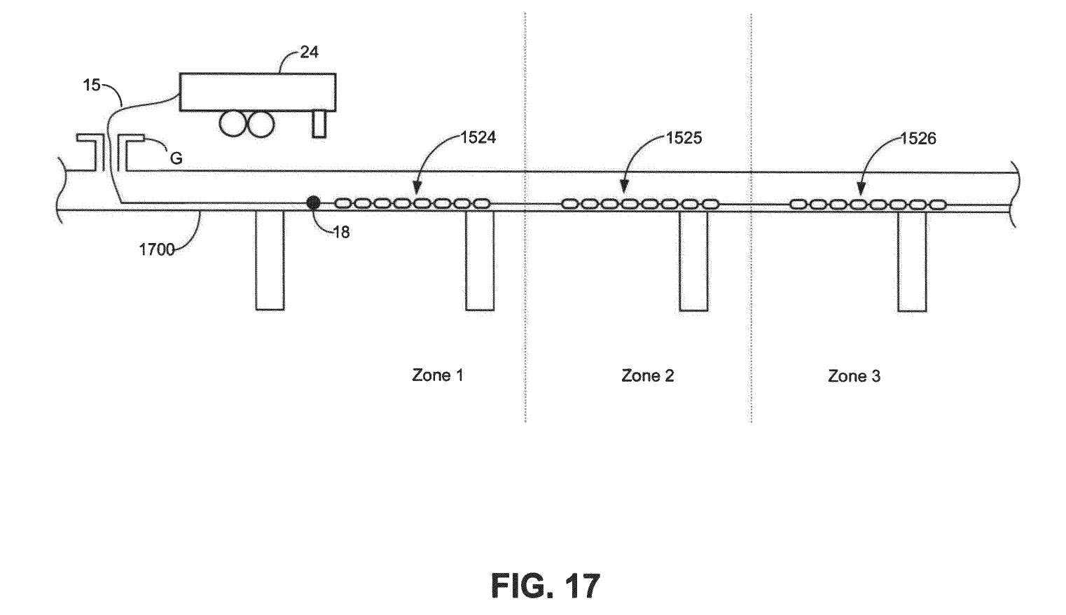

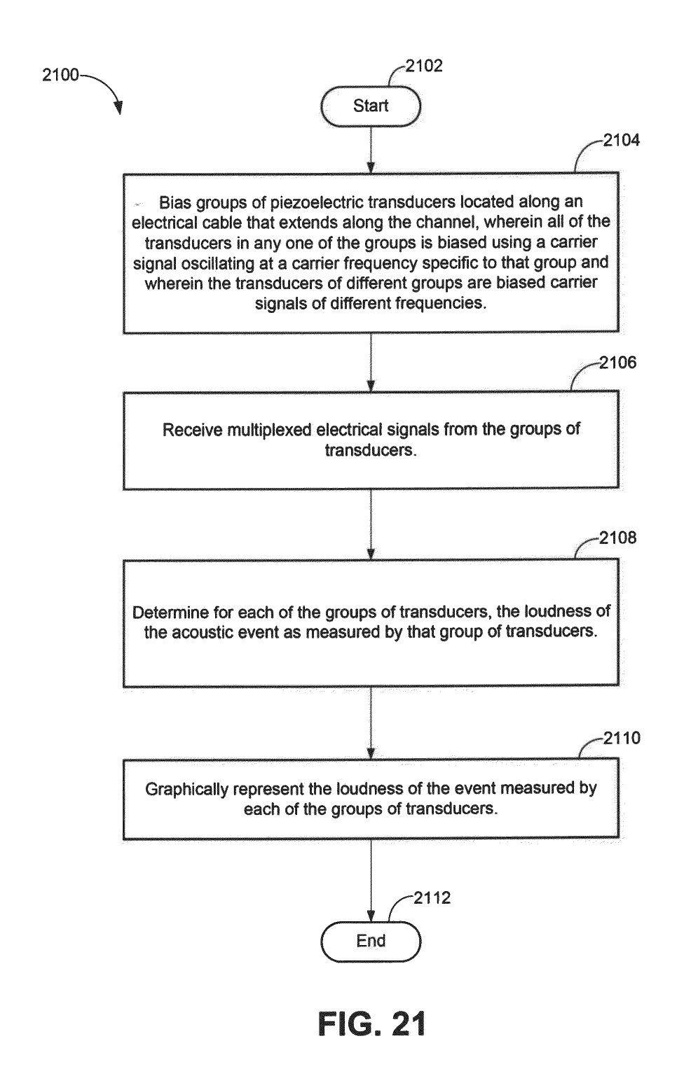

FIGS. 15 through 21 depict alternative exemplary embodiments in which transducers are grouped together at various zones along the fiber optic cable 15. In FIG. 15, a wellbore is divided into Zones 1 through 3, with a group of transducers placed in each zone. In FIG. 16, a production well on which fracking is performed is divided into Zones 1 through 3, and a group of transducers is placed above each zone in a neighboring observation well. In FIG. 17, a pipeline is divided into Zones 1 to 3 and again a group of transducers is placed in each zone. WDM is used to simultaneously obtain measurements from the different groups of transducers in each zone, with the result being the ability to monitor, in real-time and with a relatively high SNR, events that may be occurring in any one or more of the zones; by “real-time”, it is meant that the operator of the apparatus 10 is presented with refreshed data approximately once per second. In the depicted embodiments, each of the transducers is similar in structure to the transducers 64 depicted in FIG. 3; that is, each of the transducers in FIGS. 15 to 17 comprise two fiber Bragg gratings with an intervening length of unetched fiber optic line. In alternative embodiments, however, alternative sensors that output signals of sufficiently high SNR may be used, regardless of whether they may be used with optical signals; for example, in one alternative embodiment discussed in respect of FIG. 21 below, piezoelectric sensors may be used.

Referring now to FIG. 15, there is shown a schematic of another embodiment of the apparatus 10, in which the apparatus 10 is used for detecting an acoustic event along a channel, which in the depicted embodiment is production tubing F within the wellbore A, which in FIG. 15 is horizontal. In FIG. 15, the wellbore A is drilled into a formation E that contains oil or gas deposits (not shown). Various casing and tubing strings are then strung within the wellbore A to prepare it for production. In FIG. 15, surface casing C is the outermost string of casing and circumscribes the top portion of the interior of the wellbore A shown in FIG. 15. A string of production casing D with a smaller radius than the surface casing C is contained within the surface casing C, and an annulus (unlabeled) is present between the production and surface casings D,C. A string of the production tubing F is contained within the production casing D and has a smaller radius than the production casing D, resulting in another annulus (unlabeled) being present between the production tubing F and casing D. The surface and production casings C,D and the production tubing F terminate at the top of the wellbore A in the wellhead B through which access to the interior of the production tubing F is possible.

Although the wellbore A in FIG. 15 shows only the production and surface casings D,C and the production tubing F, in alternative embodiments (not shown) the wellbore A may be lined with more, fewer, or alternative types of tubing or casing. For example, in one such alternative embodiment a string of intermediate casing may be present in the annulus between the surface and production casings C,D. In another such alternative embodiment in which the wellbore A is pre-production, only the surface casing C, or only the surface and production casings C,D, may be present.

FIG. 15 also shows two exemplary acoustic events that the apparatus 10 can be used to monitor. Production 1528a is depicted as production fluid flowing from the formation E to within the production tubing F via perforations (not shown) in the production tubing F, while a leak 1528b in the production casing D is depicted as fluid crossing the production casing D, regardless of whether this fluid is entering or leaving the production casing D (collectively, production 1528a and the leak 1528b are referred to as “acoustic events 1528”); the leak 1528b across the production casing D may represent sanding, water flow, and steam injection, for example. In alternative embodiments (not shown), the apparatus 10 may also be used for monitoring of any type of CVF or GM, regardless of whether the CVF or GM crosses the production casing D.

Lowered through the wellhead B and into the wellbore A, through the production tubing F, is the fiber optic cable assembly 14. The fiber optic sensor assembly 14 includes the fiber optic cable 15 that is optically coupled, via the optical connector 18, to three groups of transducers: a first group that comprises eight transducers 1524a-f, a second group that comprises another eight transducers 1525a-f, and a third group that comprises another eight transducers 1526a-f. As labeled on FIG. 15, the portion of the wellbore A that the first group of transducers 1524a-f monitors is “Zone 1”, the portion of the wellbore A that the second group of transducers 1525a-f monitors is “Zone 2”, and the portion of the wellbore A that the third group of transducers 1526a-f monitors is “Zone 3”, where Zone 1 spans a length nearer to the wellhead B than Zone 2 and Zone 2 spans a length nearer to the wellhead B than Zone 3: the first group of transducers 1524a-f is accordingly hereinafter referred to as the “Zone 1 transducers 1524”, the second group of transducers 1525a-f is accordingly hereinafter referred to as the “Zone 2 transducers 1525”, and the third group of transducers 1526a-f is accordingly hereinafter referred to as the “Zone 3 transducers 1526”. To protect the fiber optic cable 15 from downhole trauma, it is contained within a metal tube (not shown). While the Zones 1 through 3 transducers 1524-1526 each comprise eight transducers, in alternative embodiments (not shown) more or fewer transducers may be used per group. Furthermore, in the depicted embodiments, the transducers 1524,1525 in any given group are consecutively spaced along the fiber optic cable 15; in alternative embodiments, however, this may not be the case, and different types of sensors or transducers may be interspersed between the transducers 1524-1526 of any given group.

Each of the Zone 1 transducers 1524 is tuned to reflect a particular wavelength of light, which is hereinafter referred to as the “tuned wavelength” of the transducers 1524. Similarly, each of the Zone 2 transducers 1525 is tuned to reflect another tuned wavelength, which is different from the tuned wavelength of the Zone 1 transducers 1524, and each of the Zone 3 transducers 1526 is tuned to reflect another tuned wavelength, which is different from the tuned wavelength of the Zone 1 and 2 transducers 1525,1525. In the depicted embodiment, the tuned wavelengths are the Bragg wavelengths of the fiber Bragg gratings of the transducers 1524-1526. As discussed in further detail below, the optical signal processing equipment 26 uses WDM to simultaneously receive and distinguish between signals reflected by the Zones 1 through 3 transducers 1524-1526.

As discussed above in respect of the embodiment of FIG. 2, the fiber optic strands themselves may be made from quartz glass (amorphous SiO₂). The fiber optic strands may be doped with a rare earth compound, such as germanium, praseodymium, or erbium oxides to alter their refractive indices. Single mode and multimode optical strands of fiber are commercially available from, for example, Corning® Optical Fiber. Exemplary optical fibers include ClearCurve™ fibers (bend insensitive), SMF28 series single mode fibers such as SMF-28 ULL fibers or SMF-28e fibers, and InfiniCor° series multimode fibers.

When any of the transducers 1524-1526 experience strain in response to an applied pressure, the tuned wavelengths of the transducers 1524-1526 change, which is detected by the interferometer that forms part of the optical signal processing equipment 26 as discussed above. The degree of interference between wavelengths accordingly corresponds to the magnitude of the pressure applied to, and the strain experienced by, the transducers 1524-1526.

The signals output by the transducers 1524-1526, which in the embodiment of FIG. 15 is reflected laser light at certain wavelengths, are transmitted along the fiber optic cable 15, past the spool 19 around which the fiber optic cable 15 is wrapped, and to a data acquisition box 1510, which forms part of the optical signal processing equipment 26. The data acquisition box 1510 digitizes the signals and sends them to a signal processing device 1508 for further analysis; the signal processing device 1508 also forms part of the optical signal processing equipment 26. The digital acquisition box 1510 may be, for example, an Optiphase™ TDI7000. The digital acquisition box 1510 detects deviations of the optical signal reflected by the transducers 1524-1526 from the tuned wavelength, and determines the magnitude of the strain that the transducers 1524-1526 are experiencing from these deviations.

The signal processing device 1508 is communicatively coupled to both the data acquisition box 1510 to receive the digitized signals and to the spool 19 to be able to determine the depths at which the signals were generated (i.e. the depths at which the transducers 1524-1526 were when they measured the acoustic event that places the transducers 1524-1526 under strain), which the spool 19 automatically records. The signal processing device 1508 includes a processor 1504 and a non-transitory computer readable medium 1506 that are communicatively coupled to each other. The computer readable medium 1506 includes statements and instructions to cause the processor 1504 to perform any one or more of the exemplary methods discussed below, which are used to determine one or both of when and where the event occurs along the channel, which in FIG. 15 is the wellbore A, along with the loudness of the event. The spool 19, data acquisition box 1510, and signal processing device 1508 are all contained within the surface data acquisition unit 24 to facilitate transportation to and from the wellbore A.

FIGS. 15 to 17 illustrate examples of various channels with which the apparatus 10 may be used. As discussed above, FIG. 15 shows an embodiment in which the channel is the wellbore A and the apparatus 10 is used to detect, for example, production 1528a. Movement of production fluid such as oil or gas emits a noise that propagates in space as a pressure wave; this pressure wave strikes the transducers 1524-1526, which places them under strain and which is subsequently detected by the optical signal processing equipment 26. In the embodiment of FIG. 15, the cable assembly 14 is permanently installed in the wellbore A and used to perform production logging on a long-term basis. In alternative embodiments (not depicted), the cable assembly 14 is installed on a temporary basis and may be removed during the life of the wellbore A.

FIG. 16 shows another embodiment in which the apparatus 10 is used during hydraulic fracturing (“fracking”). In FIG. 16, two wells are shown that are roughly parallel to each other: a fracking well 1604 and an observation well 1602. At the wellhead B′ of the fracking well 1604 is a derrick 1608. Fracking is performed on the fracking well 1604 to result in three pairs of fractures in the formation: a first pair comprising two fractures 1606a,b; a second pair comprising two more fractures 1606c,d that are located further from the wellhead B′ than the first pair; and a third pair comprising an additional two fractures 1606e,f that are located further from the surface than the second pair (collectively, “fractures 1606”). The observation well 1602 is vertically offset from and is shallower than the fracking well 1604. In an alternative embodiment (not depicted), the observation well 1602 may be positioned differently relative to the fracking well 1604; for example, the observation well 1602 may be at the same depth as, but laterally offset from, the fracking well 1604. At the wellhead B of the offset well 1602 is the surface data acquisition unit 24, from which extends the optic cable 15. Along the optic cable 15 are the Zone 1 transducers 1524, which are placed above the first pair of fractures 1606a,b and the Zone 2 transducers 1525, which are placed above the second pair of fractures 1606c,d, and the Zone 3 transducers 1526, which are placed above the third pair of fractures 1606e,f.

During production, creation or expansion of the fractures 1606 is an acoustic event that Zones 1, 2, and 3 transducers 1524-1526 in the observation well 1602 detect. As in the embodiment of FIG. 15, this noise causes the fiber optic cable 15 to experience strain, which the optical signal processing equipment 26 detects.

FIG. 17 shows a portion of a pipeline 1700 on which the apparatus 10 is used. The pipeline 1700 has a port G near which the surface data acquisition unit 24 is stationed. The optic cable 15 extends into and along the pipeline 1700 from the surface data acquisition unit 24 via the wellhead 1702. As in the embodiment of FIG. 16, the Zones 1, 2, and 3 transducers 1524-1526 are located along the optic cable 15 at locations increasingly removed from the wellhead G. In this embodiment, the apparatus 10 is used to detect leaks in the pipeline 1700. A leak in the pipeline 1700 in the vicinity of one of the Zones creates a pressure change and consequently an acoustic signature that is detectable by the transducers 1524-1526 for that Zone, and that the optical signal processing equipment 26 accordingly processes and records.

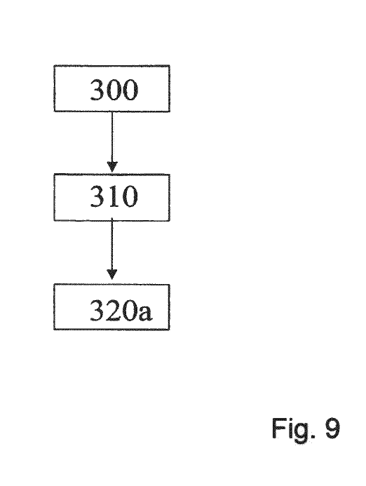

As mentioned above in respect of the embodiments of FIGS. 1 to 14, following their acquisition the signals from the transducers 1524-1526 are filtered by the optical signal processing equipment 26. In the embodiments of FIGS. 15 through 21, the optical signal processing equipment 26 conditions the signals prior to performing any further signal processing on them. In order to condition the signals for further processing, in the depicted embodiment the optical signal processing equipment 26 filters the signals through a 10 Hz high pass filter, and then in parallel through a bandpass filter having a passband of between about 10 Hz to about 200 Hz, a bandpass filter having a passband of about 200 Hz to about 600 Hz, a bandpass filter having a passband of about 600 Hz to about 1 kHz, a bandpass filter having a passband of about 1 kHz to about 5 kHz, a bandpass filter having a passband of about 5 kHz to about 10 kHz, a bandpass filter having a passband of about 10 kHz to about 15 kHz, and a high pass filter having a cutoff frequency of about 15 kHz. The optical signal processing equipment 26 can digitally implement the filters as, for example, 5^{th} or 6^{th} order Butterworth filters. By filtering the signals in parallel in this manner, the optical signal processing equipment 26 is able to isolate different types of the acoustic events that correspond to the passbands of the filters. In an alternative embodiment (not shown), the filtering performed on the signals may be analog, or a mixture of analog and digital, in nature, and alternative types of filters, such as Chebychev or elliptic filters with more or fewer poles than those of the Butterworth filters discussed above may also be used, for example in response to available processing power.

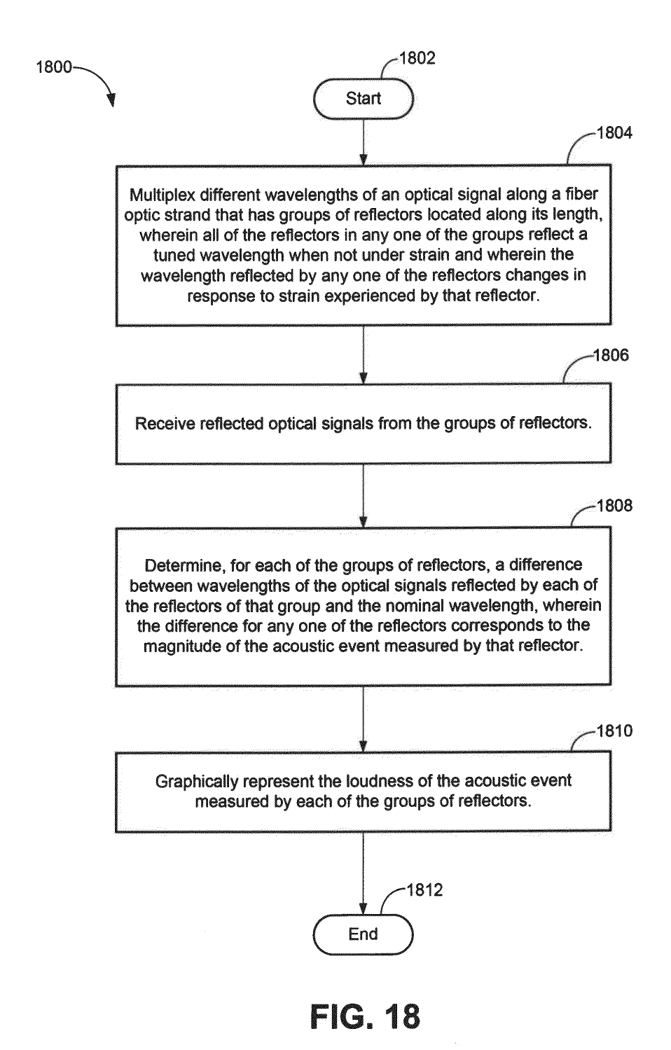

Referring now to FIG. 18, there is shown an embodiment of a method 1800 for detecting an acoustic event along a channel. The channel may be, for example, the wellbore A of FIG. 15, the fracking well 1604 of FIG. 16, or the pipeline 1700 of FIG. 17, while the acoustic event may be, for example, the acoustic events 1528 of FIG. 15; creation or expansion of some of the fractures 1606 of FIG. 16; or a leak along the pipeline 1700 of FIG. 17, respectively. The optical signal processing equipment 26 begins at block 1802 and proceeds to block 1804 at which it uses WDM to multiplex different wavelengths of an optical signal, such as laser light, along one of the fiber optic strands in the optic cable 15. When the Zones 1 through 3 transducers 1524-1526 are used, exemplary wavelengths of the optical signal are selected from the range of about 1,450 nm to about 1,600 nm. Each of the Zones 1 through 3 transducers 1524-1526 reflect its tuned wavelength when not under strain. However, when placed under strain by the acoustic event, the wavelength of light that the transducers 1524-1526 reflect changes. The optical signal processing equipment 26 then proceeds to block 1806 where it receives the signals reflected by the Zones 1 through 3 transducers 1524-1526 via the data acquisition box 1510. Following receipt, the optical signal processing equipment 26 proceeds to block 1808 where it determines, for each of the Zones, how much the wavelengths of the reflected optical signals deviate from the tuned wavelength for that Zones' transducers 1524-1526, and the optical signal processing equipment 26 interprets these deviations as the loudness of the acoustic event detected by that Zones' transducers 1524-1526.

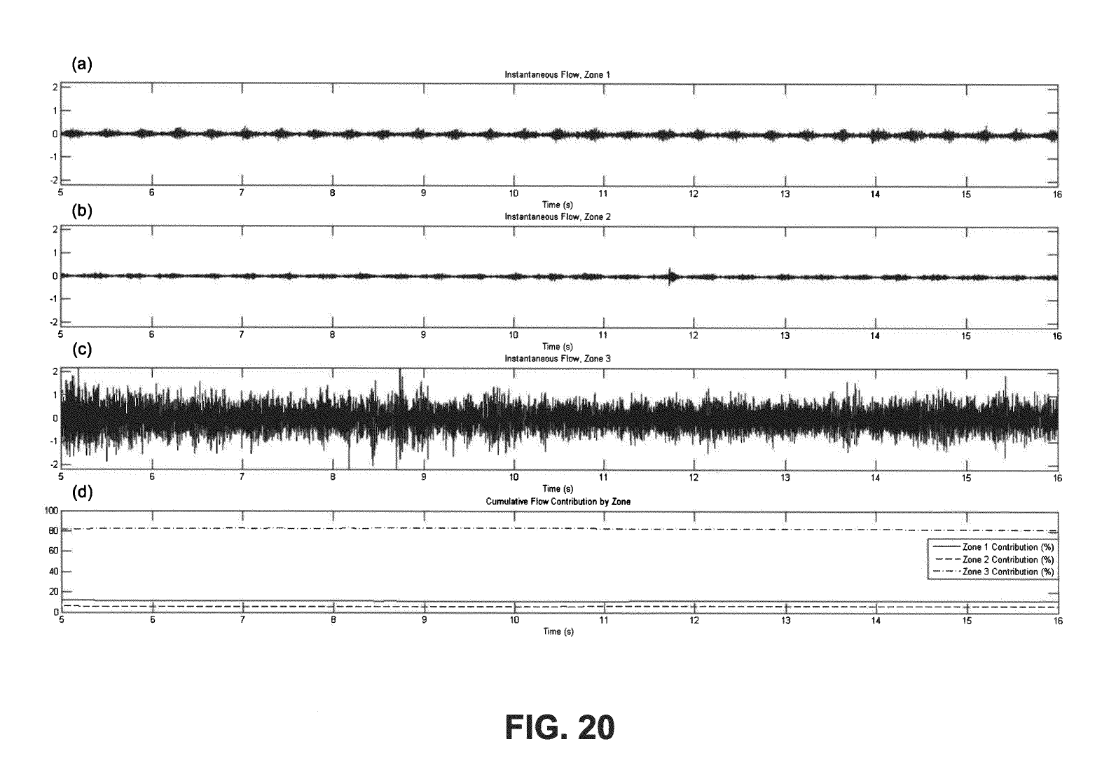

The optical signal processing equipment 26 then proceeds to block 1810 where it graphically represents the loudness of the acoustic event by displaying the magnitude of the signals from the Zones' transducers 1524-1526 for review by the apparatus 10's operator. FIGS. 20(a)-(c) show the results of such a calculation for the embodiment of FIG. 17 in which the pipeline 1700 has a leak in Zone 3. While FIGS. 20(a) and (b) show that the Zone 1 transducers 1524 and the Zone 2 transducers 1525 measure relatively little activity, FIG. 20(c) shows that the Zone 3 transducers 1526 detect the pressure changes resulting from oil leaking out of the pipeline 1700. FIG. 21(d) shows the relative contribution of the signals measured using each of the Zones through 3 transducers 1524-1526, which emphasizes the leak in the pipeline 1700 being in Zone 3.

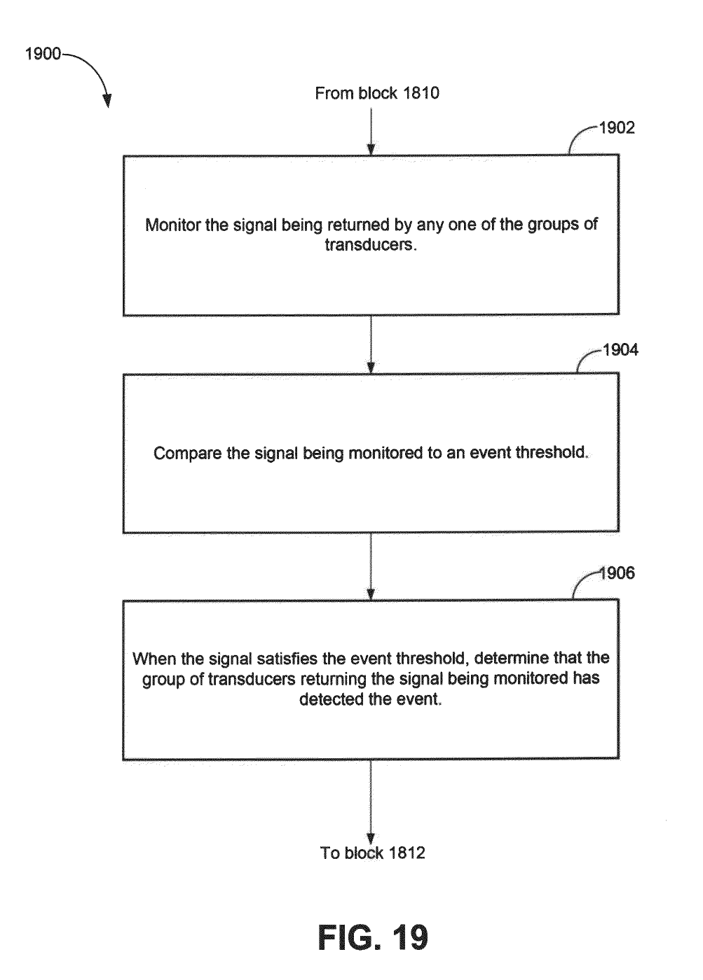

FIG. 19 depicts another embodiment of a method 1900 for detecting when the acoustic event occurs at a given location along the channel. In this method 1900, the optical signal processing equipment 26 proceeds to block 1902 from block 1810 and monitors the signal being returned by any one of the Zones 1 through 3 transducers 1524-1526. The optical signal processing equipment 26 compares the signal to an event threshold at block 1904. When the signal surpasses the event threshold, the optical signal processing equipment 26 at block 1906 determines that whichever of the Zones 1 through 3 transducers 1524-1526 that returned the signal being monitored has detected the event, and the optical signal processing equipment 26 alerts the apparatus 10's operator that the event is occurring. For example, when the apparatus 10 is used to monitor the pipeline 1700, the signal from the Zone 3 transducers 1526 exceeding the event threshold may indicate that the pipeline 1700 has a leak in Zone 3. In an alternative embodiment (not depicted), the optical signal processing equipment 26 may additionally or alternatively simultaneously monitor the signals returned by at least two of the Zones 1 through 3 transducers 1524-1526 and compare the signals sampled at any given time to the event threshold. When any one of the signals exceeds the event threshold, the optical signal processing equipment 26 alerts the apparatus 10's operator that an event has been detected in the Zone from which the signal originated by, for example, triggering an alarm.

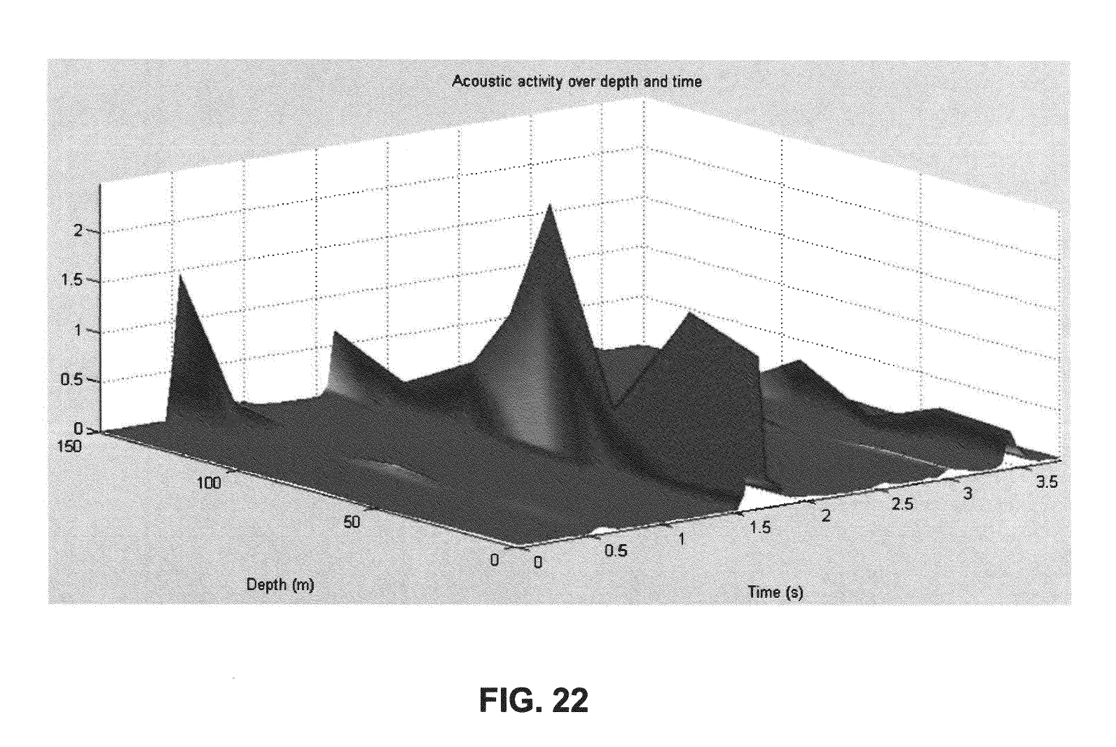

While the exemplary embodiments depict only two or three zones, in alternative embodiments the apparatus 10 may have sufficient groups of transducers to accommodate hundreds of zones, which increases the precision of the measurements that the apparatus 10 can acquire. The optical signal processing equipment 26 may also monitor, record, and graph the signals returned by the transducers over time. The results that the optical signal processing equipment 26 records can then be graphed to generate a 3-dimensional graph of signal magnitudes vs. depth vs. time, with each of the depths for which data is collected being analogous to the depth of one of the groups of transducer and one of the Zones of FIGS. 15 to 17. An exemplary graph is shown in FIG. 22, in which normalized magnitudes of the acoustic signals returned by the groups of transducers are graphed against depth and time.

Examining the magnitudes of the signals returned by the groups of transducers at different depths allows the operator of the apparatus 10 to track the location and loudness of a transient acoustic event. For example, in FIG. 22, an acoustic event occurs at approximately 1.5 seconds at a depth of approximately 75 m, which is detected by a group of transducers at 75 m. The acoustic event is also measured by a group of transducers at approximately 25 m, but with less intensity. The relative magnitude of the acoustic signal at 75 m vs. the magnitude of the signal at 75 m shows that the acoustic event is nearer to 75 m than 25 m. Increasing the number of groups of transducers can accordingly increase the resolution of the apparatus 10. While FIG. 22 shows normalized magnitudes of the acoustic signals, in alternative embodiments (not shown) different measures of magnitude may also be used; for example, RMS values, peak values, or average values may be graphed.

Distributed acoustic sensing (DAS) refers to a method that uses fiber optic cables to provide distributed strain sensing. In Rayleigh scatter based DAS, coherent laser light is shone into an input end of an optical fiber and transmitted along the fiber. Spaced along the fiber are optical scattering sites that are sensitive to the strain that the fiber is experiencing; different intensities of light are reflected back to the input end of the fiber depending on the strain the fiber is experiencing. Optoelectronic circuitry at the input end of the fiber measures the intensity of the reflected light over time. The strain the fiber is experiencing over time can be determined from the measured intensity of the reflected light.

The embodiments of FIGS. 15 through 20 contrast favorably with a system such as distributed acoustic sensing (DAS). DAS typically is incapable of real-time operation at a relatively high fidelity; that is, when operating a conventional DAS system, achieving real-time operation generally comes at the cost of a lower SNR. This tradeoff results from the fact that DAS relies on Rayleigh scattering, and the intensity of light reflected using Rayleigh scattering is relatively low. Consequently several seconds of reflected light are measured before sufficient reflected light is collected to be able to generate a new reading of an adequate SNR. For example, in lab tests done using fiber strands having similar coatings placed in a water-filled trough and exposed to identical acoustic events, experimentally it has been determined that while a DAS system has an SNR of approximately 2 under these conditions, under the same conditions the embodiments of FIGS. 15 through 20 has an SNR of approximately 300.

Referring now to FIG. 21, there is shown another embodiment of a method 2100 for detecting an acoustic event along a channel in which piezoelectric transducers are used instead of fiber Bragg gratings. As discussed above, the channel may be, for example, the wellbore A of FIG. 15, the fracking well 1604 of FIG. 16, or the pipeline 1700 of FIG. 17, and the acoustic event may be, for example, the acoustic events 1528 of FIG. 15; creation or expansion of some of the fractures 1606 of FIG. 16; or a leak along the pipeline 1700 of FIG. 17, respectively. Accordingly, in lieu of the optical signal processing equipment 26, conventional electrical signal processing equipment (not shown) is used to communicate with the piezoelectric transducers which are positioned along an electrical cable (not shown) that is laid along the channel. The electrical signal processing equipment begins at block 2102 and proceeds to block 2104 at which it uses carrier signals oscillating at different carrier frequencies to bias different groups of the transducers; each of the different groups of transducers is biased using a different carrier frequency in, for example, the MHz range. When the piezoelectric transducers are placed under strain, the piezoelectric transducers modulate the electrical signals; in the depicted embodiment, either amplitude modulation in which the magnitude of the signal varies in proportion to the loudness of the acoustic event or frequency modulation in which the frequency of the signal varies in proportion to the loudness of the acoustic event may be used. The electrical signal processing equipment then proceeds to block 2106 where it receives the signals modulated by the different groups of piezoelectric transducers; for example, in embodiments analogous to those depicted in FIGS. 16 and 17, the electrical signal processing equipment receives signals multiplexed using three different carrier frequencies from the transducers located in Zones 1 through 3. The electrical signal processing equipment then proceeds to block 2108 where it determines, from deviations in magnitude (for amplitude modulation) or deviation in frequency (for frequency modulation) of the signals returned by the transducers, the loudness of the acoustic event as measured by each group of transducers. The electrical signal processing equipment then graphically represents the loudness of the acoustic event by displaying the signals returned by the groups of transducers to an operator of the apparatus 10, which allows the operator to determine which zone the acoustic event is nearest based on how loud the acoustic event was to the transducers present in that zone. In another alternative embodiment (not depicted), microseismic sensors such as geophones may be used in lieu of piezoelectric sensors or fiber Bragg gratings.

The foregoing description of the embodiment of FIG. 21 describes frequency division multiplexing; however, in alternative embodiments, different types of multiplexing may be used. For example, alternative embodiments may use time division multiplexing.

The processor used in the foregoing embodiments may be, for example, a microprocessor, microcontroller, programmable logic controller, field programmable gate array, or an application-specific integrated circuit. Examples of the computer readable medium 106 are non-transitory and include disc-based media such as CD-ROMs and DVDs, magnetic media such as hard drives and other forms of magnetic disk storage, semiconductor based media such as flash media, random access memory, and read only memory.

It is contemplated that any part of any aspect or embodiment discussed in this specification can be implemented or combined with any part of any other aspect or embodiment discussed in this specification.

For the sake of convenience, the exemplary embodiments above are described as various interconnected functional blocks. This is not necessary, however, and there may be cases where these functional blocks are equivalently aggregated into a single logic device, program or operation with unclear boundaries. In any event, the functional blocks can be implemented by themselves, or in combination with other pieces of hardware or software.

All citations disclosed herein are hereby incorporated by reference.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A method for detecting an acoustic event along a channel, the method comprising:
(a) multiplexing different wavelengths of an optical signal along a fiber optic strand extending along the channel that has groups of transducers located along its length, wherein all of the transducers in any one of the groups reflect a tuned wavelength when not under strain and wherein the wavelength reflected by any one of the transducers changes in response to strain experienced by that transducer;
(b) receiving reflected optical signals from the groups of transducers;
(c) determining, for each of the groups of transducers, differences between wavelengths of the optical signals reflected by the transducers of that group and the tuned wavelength for that group, wherein the differences correspond to the loudness of the event measured by that group of transducers; and
(d) graphically representing the loudness of the event measured by each of the groups of transducers.

2. A method as claimed in claim 1 wherein none of the tuned wavelengths of any of the groups of transducers is identical.

3. A method as claimed in claim 1 wherein the transducers comprise fiber Bragg gratings.

4. A method as claimed in claim 1 wherein the tuned wavelengths of each of the transducers of any one of the groups are identical.

5. A method as claimed in claim 1 wherein all of the transducers in any one of the groups are located consecutively along the fiber strand.

6. A method as claimed in claim 1 further comprising:
(a) monitoring the signal being returned by any one of the groups of transducers;
(b) comparing the magnitude of the signal being monitored to an event threshold; and
(c) when the magnitude of the signal satisfies the event threshold, determining that the group of transducers returning the signal being monitored has detected the event.

7. A method as claimed in claim 6 wherein signals being returned by at least two of the groups of transducers are simultaneously monitored and compared to the event threshold.

8. A method as claimed in claim 1 further comprising estimating location of the acoustic event over a period of time by performing a method comprising:
(a) determining magnitudes of the signals returned by the groups of transducers during the period of time; and
(b) determining the location of the acoustic event as being nearest to the group of transducers having the highest magnitude during the period of time.

9. A method as claimed in claim 1 wherein the channel comprises production tubing extending within production casing.

10. A method as claimed in claim 9 wherein the event comprises one or both of oil and gas passing through the production casing.

11. A method as claimed in claim 9 wherein the event is selected from the group consisting of: sanding, water flow, and steam injection.

12. A method as claimed in claim 1 wherein the channel comprises a pipeline.

13. A method as claimed in claim 12 wherein the acoustic event comprises a leak in the pipeline.

14. A method as claimed in claim 1 wherein the channel comprises a fracking observation well.

15. A method as claimed in claim 14 wherein the acoustic event comprises creation or expansion of a fracture from a fracking well.

16. An apparatus for detecting an acoustic event along a channel, the apparatus comprising:
(a) a fiber optic sensor assembly comprising groups of transducers spaced from each other along a fiber optic strand, wherein each of the groups of transducers is configured to measure the acoustic event and output a signal;
(b) optical signal processing equipment communicatively coupled to the sensor assembly and configured to digitize the signals and to perform a method as claimed in claim 1.

17. A non-transitory computer readable medium having statements and instructions encoded thereon to cause a processor to perform a method as claimed in claim 1.

18. A method for detecting an acoustic event along a channel, the method comprising:
(a) biasing groups of piezoelectric transducers located along an electrical cable extending along the channel, wherein all of the transducers in any one of the groups is biased using a carrier signal oscillating at a carrier frequency specific to that group and wherein the transducers of different groups are biased using carrier signals of different frequencies;
(b) receiving frequency multiplexed electrical signals from the groups of transducers;
(c) determining, for each of the groups of transducers, the loudness of the acoustic event as measured by that group of transducers; and
(d) graphically representing the loudness of the event measured by each of the groups of transducers.

19. A method as claimed in claim 18 wherein the electrical signals are amplitude modulated in proportion to the loudness of the acoustic event.

20. A method as claimed in claim 18 wherein the electrical signals are frequency modulated in proportion to the loudness of the acoustic event.
